(19) United States
(12) Patent Application Publication
(10) Pub. No.: US 2023/0395289 A1
(43) Pub. Date: Dec. 7, 2023

(54) MAGNETIC NANOCOMPOSITE MATERIALS SUITABLE FOR MAGNETIC LOCALIZED POLYMERISATION OF AN ANAEROBIC ADHESIVE

(71) Applicant: Nanyang Technological University, Singapore (SG)

(72) Inventors: Pooi See LEE, Singapore (SG); Haruethai Kongcharoen, Singapore (SG)

(21) Appl. No.: 18/251,173

(22) PCT Filed: Nov. 25, 2021
(86) PCT No.: PCT/SG2021/050726

§ 371 Date: Apr. 28, 2023

(30) Foreign Application Priority Data
Nov. 25, 2020 (SG) 10202011744P

(51) Int. Cl. H01F 1/00; C08J 5/00; C08J 5/24

(52) U.S. Cl. CPC H01F 1/0054; H01F 1/0063; C08J 5/005; C08J 5/249

(57) ABSTRACT

Provided is the use of a magnetic nanocomposite material that is capable of polymerising an anaerobic adhesive or other monomeric materials in need thereof as a nanoinitiator, in said polymerisation. Also disclosed herein is a method of manufacturing the magnetic nanocomposite material. In a preferred embodiment, the nanoinitiator is a magnetic nanoparticle core covered with a shell bearing dendrons that chelate an initiating metal ion of copper.

### FIELD OF INVENTION

This invention relates to a magnetic nanocomposite material that is capable of polymerising an anaerobic adhesive or other monomeric materials in need thereof. Also disclosed herein is the use of the material in said polymerisation and its method of manufacture.

### BACKGROUND

The listing or discussion of a prior-published document in this specification should not necessarily be taken as an acknowledgement that the document is part of the state of the art or is common general knowledge.

Many air-sensitive reactions or manufacturing processes for the production of polymers intrinsically require an anaerobic atmosphere to avoid interactions with reactive or unstable forms of oxygen, which can produce undesirable by-products. Anaerobic adhesives are intentionally designed for use under low oxygen or deoxygenated conditions that are found in sophisticated, complex, and tight spaces or surface irregularity. As such, anaerobic adhesives are often colloquially known as threadlockers or retaining compounds. These adhesives cure on active metal surfaces in the absence of oxygen in the bond line. Thus, anaerobic adhesives are often applied in locking, sealing, retaining, and bonding, which are crucial processes in the electronics, packaging, and automobile industries, and so may be useful in reducing maintenance and leakage and thereby help keep factories running efficiently (amongst other uses). Moreover, anaerobic adhesives have great accessibility, storage longevity, and are eco-friendly, as compared to the other types of adhesives.

Anaerobic adhesives are one-component and solvent-free adhesives that consist of dimethacrylate monomers. Cross-linking occurs in the absence of oxygen based on a redox radical polymerization. The speed of the redox radical initiation can be tailored by the decomposition of the peroxide species caused by the presence of appropriate transition metal ions in the polymerization system (P. Klemarczyk & J. Guthrie, in Advances in Structural Adhesive Bonding, (Ed: D. A. Dillard), Woodhead Publishing, 2010, 96). However, conventional activation approaches, such as thermal, chemical, photochemical, redox, and mechanical means, can only initiate the polymerization and have limited control on the polymerization over the desirable area during the curing process. In addition, the conditions used for these processes tend to be relatively severe, resulting in high energy consumption, substrate damage and high cost.

Thus, there remains a need to develop a process for anaerobic adhesive curing/polymerisation under mild, hazard-free conditions.

### SUMMARY OF INVENTION

It is believed that magnetically controllable localized polymerization could overcome the challenges noted briefly above in relation to localized polymerization or adhesive formation.

Magnetically induced localized polymerization uses an external magnetic field to control localized initiation of polymerization toward the curing system in a sustainable, spontaneous, safe, eco-friendly, efficient manner that has a wide range of potential applications in both science and engineering.

It has been surprisingly found that a magnetic nanocomposite material disclosed herein can act as a co-initiator of polymerisation to provide localised polymerisation under mild reaction conditions. The invention will now be discussed by reference to the following numbered clauses.
1. A magnetic nanocomposite material, comprising:
   a core formed from a magnetic nanoparticle;
   a shell surrounding the magnetic nanoparticle, which shell comprises a plurality of anchoring elements;
   a plurality of dendrons, each covalently bonded to one of the anchoring elements, each dendron comprising a first non-final generation constitutional repeating unit, a plurality of final generation constitutional repeating units, where the plurality of final generation constitutional repeating units comprise a plurality of end groups, each end group comprising at least two functional groups capable of chelating to a metal ion; and
   a plurality of metal ions, where each metal ion is chelated to at least one of the plurality of end groups,
   wherein the plurality of metal ions is selected from one or more of the group consisting of Mn³⁺, Ce⁴⁺, Co³⁺, Cu²⁺, Fe³⁺, Cr³⁺, Mn³⁺, Ce⁴⁺, and Co³⁺.
2. The magnetic nanocomposite material according to Clause 1, wherein the magnetic nanoparticle comprises one or more metals selected from the group consisting of Fe, Ni, Co, Nd, Mn, Gd, Sm and Dy, optionally wherein the magnetic nanoparticle comprises one or more metals selected from the group consisting of Ni, Co, Zn, Cu, Mn, and Fe (e.g. the magnetic nanoparticle is formed from Fe).
3. The magnetic nanocomposite material according to Clause 1 or Clause 2, wherein the magnetic nanocomposite material has a diameter of from:
(ai) 5 to 50 nm, such as from 8 to 30 nm; or
(aii) 200 to 500 nm, such as from 220 to 400 nm.
4. The magnetic nanocomposite material according to any one of the preceding clauses, wherein the shell is a silica shell.
5. The magnetic nanocomposite material according to any one of the preceding clauses, wherein the plurality of anchoring elements comprise a linear or branched C₁ to C₁₀ alkyl chain substituted by one or more amino groups, optionally wherein each of the linear or branched C₁ to C₁₀ alkyl chain substituted by one or more amino groups is a 3-propylamino group.
6. The magnetic nanocomposite material according to any one of the preceding clauses, wherein each non-final generation constitutional repeating unit has the fragment formula 1a or 1b:

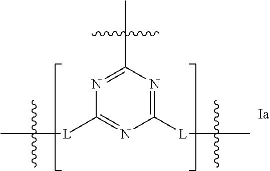

where:

the wavy lines represent the point of attachment to the rest of the molecule;

each L independently represents NR¹R² or SR³

each R¹ independently represents H or C₁ to C₆ alkyl, which C₁ to C₆ alkyl is unsubstituted;

each R² independently represents —(CHR⁴)ₙNR⁵R⁶;

each R³ independently represents —(CHR⁴)ₙSR⁷;

each R⁵ and R⁶ independently represent H, C₁ to C₆ alkyl that is unsubstituted, —(CHR⁴)ₙNR⁸R⁹, or a point of attachment to a further constitutional repeating unit or an end group;

each n independently represents 2 to 6;

each R⁸ and R⁹ independently represent H, C₁ to C₆ alkyl, which C₁ to C₆ alkyl is unsubstituted, —(CHR⁴)ₙNR¹⁰R¹¹, or a point of attachment to a further constitutional repeating unit or an end group;

each R¹⁰ and R¹¹ independently represent H, C₁ to C₆ alkyl, which C₁ to C₆ alkyl is unsubstituted, or a point of attachment to a further constitutional repeating unit or an end group;

each R⁴ represents H, OH or OR¹²; and

each OR¹² independently represents C₁ to C₃ alkyl, which C₁ to C₃ alkyl is unsubstituted; or

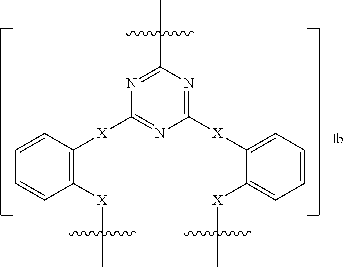

where:

each X independently represents S or NR¹³; and

each R¹³ independently represents H or C₁ to C₃ alkyl, which C₁ to C₃ alkyl is unsubstituted.
7. The magnetic nanocomposite material according to Clause 6, wherein each L is selected from the list of:

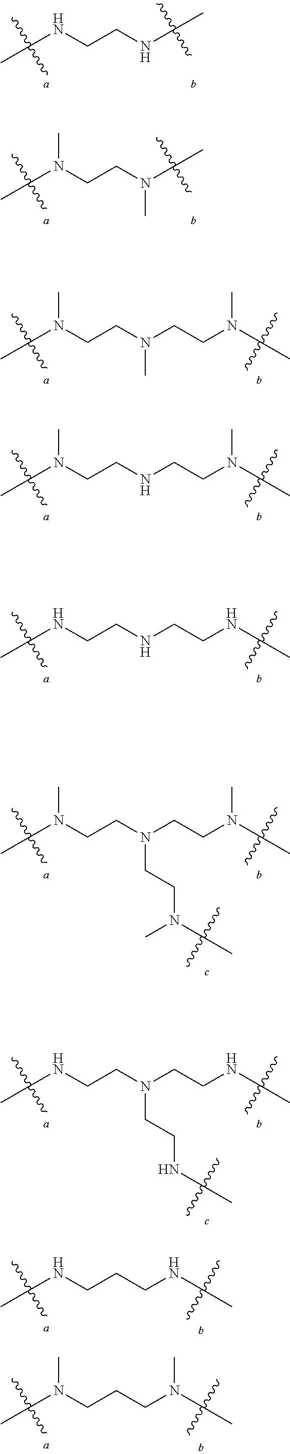

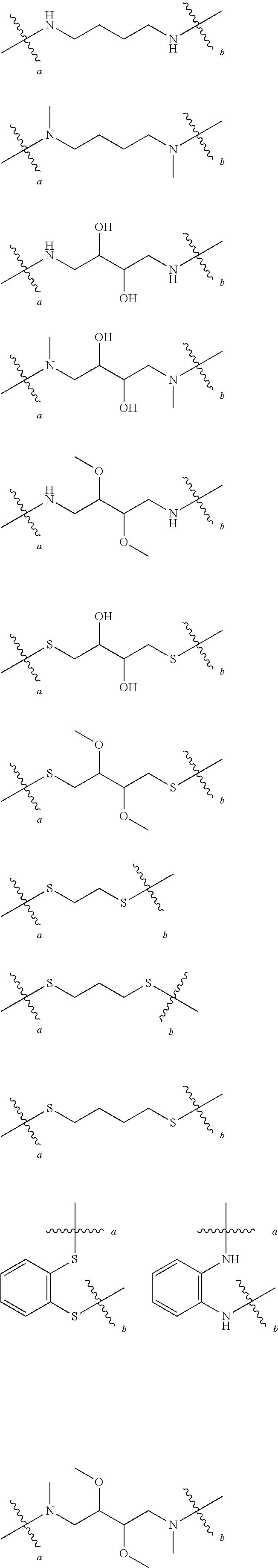

where the wavy line a represents a point of attachment to the rest of the constitutional repeating unit and the wavy lines b and, when present, c represent a point of attachment to the rest of the molecule.
8. The magnetic nanocomposite material according to Clause 7, wherein each L is selected from the list of:

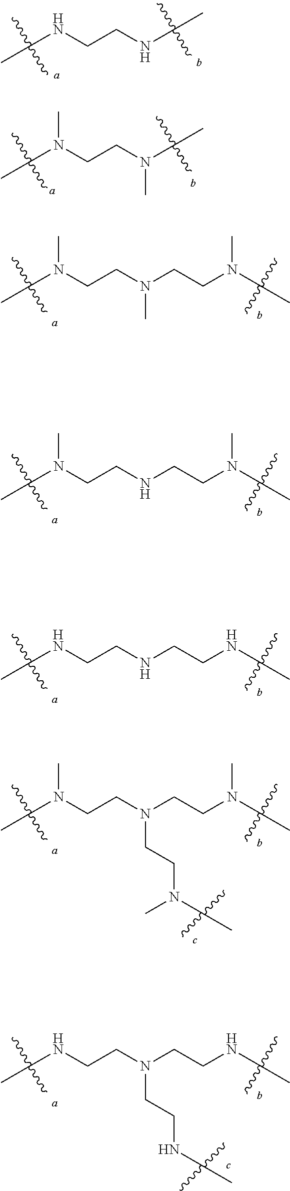

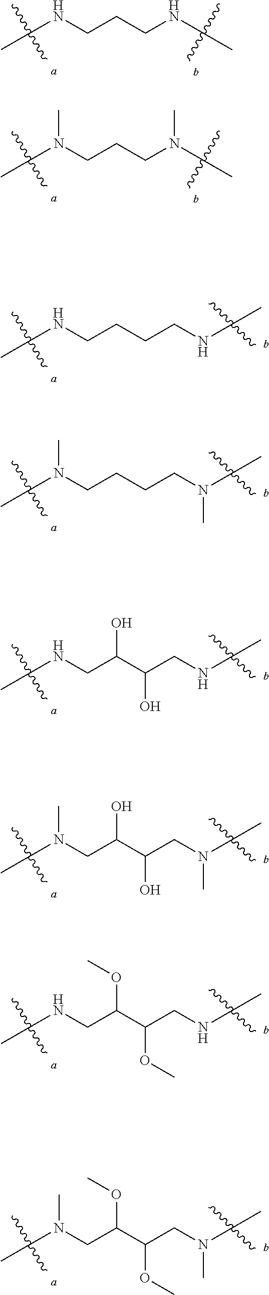

where the wavy line a represents a point of attachment to the rest of the constitutional repeating unit and the wavy lines b and, when present, c represent a point of attachment to the rest of the molecule.
9. The magnetic nanocomposite material according to Clause 8, wherein each L is selected from the list of:

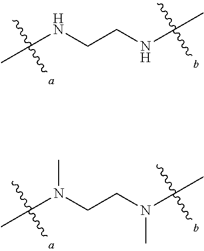

where the wavy line a represents a point of attachment to the rest of the constitutional repeating unit and the wavy line b represents a point of attachment to the rest of the molecule.
10. The magnetic nanocomposite material according to any one of the preceding clauses, wherein each final generation constitutional repeating unit comprising a plurality of end groups has the fragment formula 1a′ or 1b′:

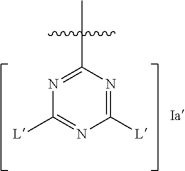

where:

the wavy line represents the point of attachment to the rest of the molecule;

each L′ independently represents an end group selected from NR^{1′}R^{2′} or SR^{3′};

each R^{1′} independently represents H or C₁ to C₆ alkyl, which C₁ to C₆ alkyl is unsubstituted;

each R^{2′} independently represents —(CHR^{4′})ₙNR^{5′}R^{6′};

each R^{3′} independently represents —(CHR^{4′})ₙSR^{7′};

each R^{5′} and R^{6′} independently represent H, C₁ to C₆ alkyl that is unsubstituted, —(CHR^{4′})ₙNR^{8′}R^{9′};

each n independently represents 2 to 6;

each R^{8′} and R^{9′} independently represent H, C₁ to C₆ alkyl, which C₁ to C₆ alkyl is unsubstituted, —(CHR⁴)ₙNR¹⁰R¹¹;

each R^{10′} and R^{11′} independently represent H, C₁ to C₆ alkyl, which C₁ to C₆ alkyl is unsubstituted;

each R^{4′} represents H, OH or OR^{12′}; and

each OR^{12′} independently represents C₁ to C₃ alkyl, which C₁ to C₃ alkyl is unsubstituted; or

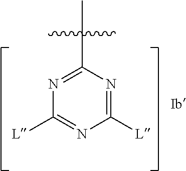

where:

the wavy line represents the point of attachment to the rest of the molecule;

each L″ independently represents an end group of formula 1c′:

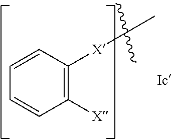

where:

the wavy line represents the point of attachment to the rest of the molecule;

each X′ independently represents S or NR¹³;

each X″ independently represents SR¹⁴ or NR^{15′}R^{16′}; and

each R^{13′} to R^{16′} independently represents H or C₁ to C₃ alkyl, which C₁ to C₃ alkyl is unsubstituted.
11. The magnetic nanocomposite material according to Clause 10, wherein each end group is selected from the list of:

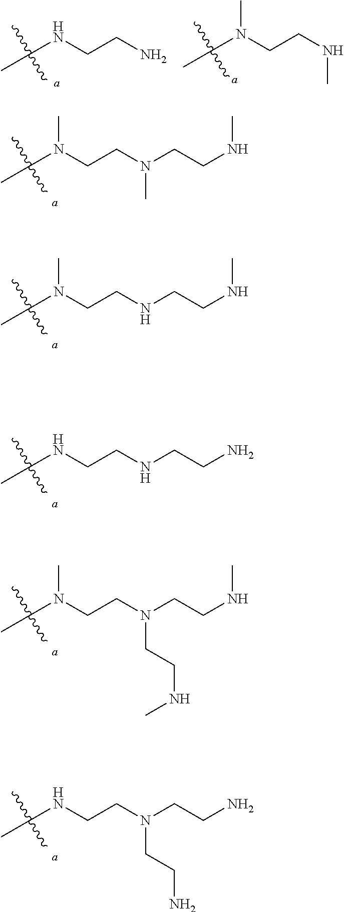

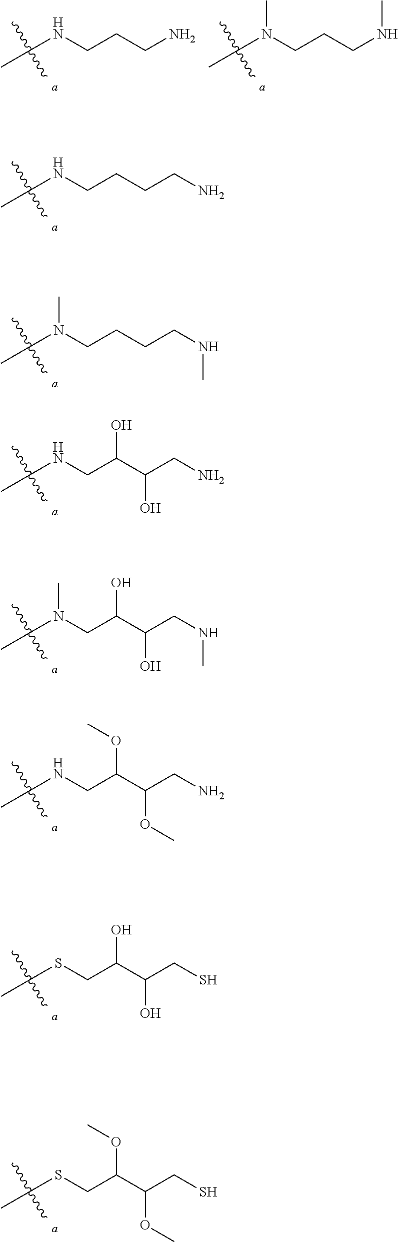

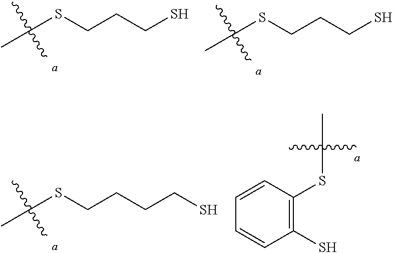

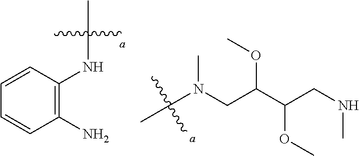 [SMILES: *Nc1ccccc1N ; *N(C)CC(OC)C(CNC)OC]

where the wavy line a represents a point of attachment to the rest of the final generation constitutional repeating unit.
12. The magnetic nanocomposite material according to Clause 11, wherein each end group is selected from the list of:

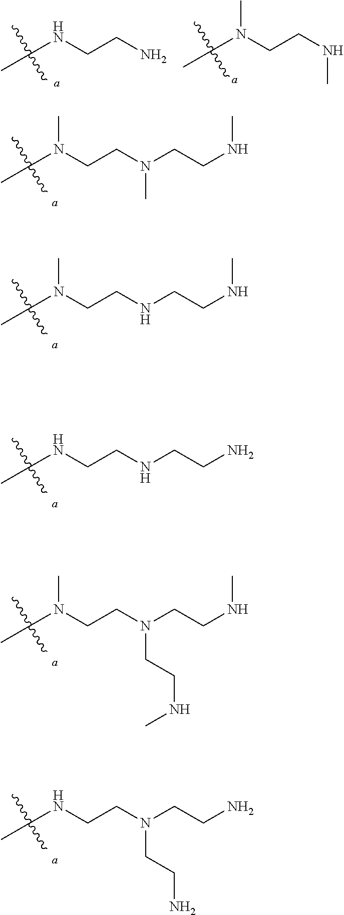

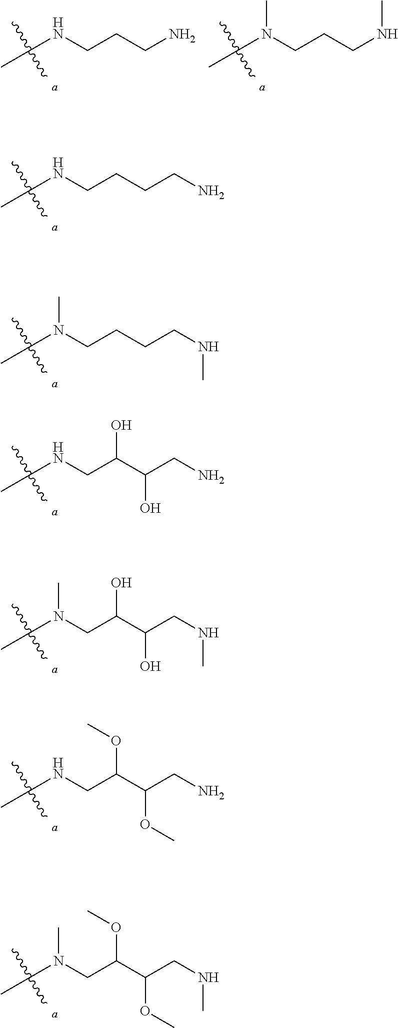

where the wavy line a represents a point of attachment to the rest of the final generation constitutional repeating unit.
13. The magnetic nanocomposite material according to Clause 12 wherein each end group is selected from the list of:

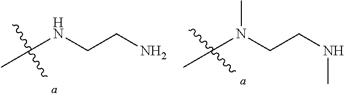

where the wavy line a represents a point of attachment to the rest of the constitutional repeating unit.
14. The magnetic nanocomposite material according to any one of the preceding clauses, wherein there are from 1 to m generations of non-final constitutional repeating units, where m is from 2 to 5.
15. The magnetic nanocomposite material according to any one of the preceding clauses, wherein plurality of metal ions is selected from one or more of the group consisting of Cu²⁺, Fe³⁺, Cr³⁺, Mn³⁺, Ce⁴⁺, and Co³⁺, optionally wherein the plurality of metal ions is Cu²+.
16. The magnetic nanocomposite material according to any one of the preceding clauses, wherein the magnetic nanocomposite material has a diameter selected from one of the following ranges:
(ai) a diameter of from 5 to 100 nm, such as from 6 to 50 nm, such as 8 to 30 nm; or
(aii) a diameter of from 200 to 500 nm, such as from 210 to 450 nm, such as from 220 to 400 nm.
17. A polymeric product comprising:
   a polymeric matrix formed from at least one monomeric material having a vinyl group; and
   a magnetic nanocomposite material according to any one of Clauses 1 to 16.
18. The polymeric product according to Clause 17, wherein the monomer in the polymeric product is selected from one or more of the group consisting of vinyl chloride, propylene, vinyl acetate, vinylidene chloride, styrene, acrylonitrile, tetrafluoroethylene, isoprene, butadiene, chloroprene, N-isopropylacrylamide, 2-hydroxyethyl methacrylate (HEMA), methyl methacrylate, ethylene glycol dimethacrylate, vinyl methacrylate, allyl methacrylate, 3-(acryloyloxy)-2-hydroxypropyl methacrylate, a dimethacrylate monomer, and triethylene glycol dimethacrylate, optionally wherein the monomer is triethylene glycol dimethacrylate.
19. The polymeric product according to Clause 17 or Clause 18, wherein the polymeric product has one or more of the following properties:
(bi) a tensile strength of from 1 to 20 MPa, such as from 8 to 15 MPa, such as from 10 to 12 MPa;
(bii) a Young's Modulus of from 10 to 300 MPa, such as from 15 to 20 MPa, such as 18 MPa, such as from 10 to 30 kPa, such as from 15 to 20 kPa, such as about 18 kPa; and
(biii) a toughness of from 0.10 to 0.50 MJ/m³, such as from 0.30 to 0.40 MJ/m³, such as 0.40 MJ/m³, such as from 250 to 500 kJ/m³, such as from 300 to 400 kJ/m³, such as 374 kJ/m³.
20. A formulation comprising:
   at least one monomeric material having a vinyl group; and
   a magnetic nanocomposite material according to any one of Clauses 1 to 16.
21. The formulation according to Clause 20, wherein the monomer is selected from one or more of the group consisting of vinyl chloride, propylene, vinyl acetate, vinylidene chloride, styrene, acrylonitrile, tetrafluoroethylene, isoprene, butadiene, chloroprene, N-isopropylacrylamide, 2-hydroxyethyl methacrylate (HEMA), methyl methacrylate, ethylene glycol dimethacrylate, vinyl methacrylate, allyl methacrylate, 3-(acryloyloxy)-2-hydroxypropyl methacrylate, a dimethacrylate monomer, and triethylene glycol dimethacrylate, optionally wherein the monomer is triethylene glycol dimethacrylate.
22. A method of forming a polymeric material, the method comprising:
(ci) forming a mixture in a vessel comprising:
   at least one monomeric material having a vinyl group
   a magnetic nanocomposite material according to any one of Clauses 1 to 16; and
   a peroxide to form a mixture: and
(cii) allowing the mixture to form the polymeric material over a period of time.
23. The method according to Clause 22, wherein step (cii) is:
(di) performed in the absence of oxygen; and/or
(dii) subjected to an activation by the application of heat to the mixture.
24. The method according to Clause 22 or Clause 23, wherein step (cii) is performed in the presence of one or more magnets, such that the polymerization occurs at one or more desired regions of the vessel.
25. The method according to Clause 24, wherein the one or more magnets are moved in a pattern, such that the resulting polymeric material conforms to the pattern provided by the one or more magnets.
26. The method according to Clause 24, wherein the one or more magnets are statically placed and the polymeric material forms at an area of the vessel corresponding to the location of the one or more magnets.
27. The method according to Clause 25 or Clause 26, wherein the magnetic nanocomposite material has a diameter of from 200 to 500 nm, such as from 210 to 450 nm, such as from 220 to 400 nm.

### DRAWINGS

FIG. 1 depicts scheme of (a) anaerobic adhesive polymerization; and (b) magnetic-dendrimer nanoinitiators (MNPs-G2@Cu²⁺).

FIG. 2 depicts the transmission electron microscopy (TEM) micrographs of (a) magnetic nanoparticles (MNPs); (b) core-shell MNPs@SiO₂ nanoparticles (NPs); (c) X-ray diffraction (XRD) spectrum of pristine MNPs; and (d) Fourier transform infrared (FTIR) spectra of surface modification on MNPs: (i) MNPs@APS; (ii) MNPS-G1; and (iii) MNPs-G2.

FIG. 3 depicts the thermogravimetric analysis (TGA) curve of (a) MNPs-APS; (b) MNPs-CC1, (c) MNPs-G1; (d) MNPs-CC2; and (e) MNPs-G2.

FIG. 4 depicts the X-ray photoelectron spectroscopy (XPS) spectra of N1s (left) and C1s (right) dendrimer modification of (a) MNPs@APS; (b) MNPs-G1; and (c) MNPs-G2.

FIG. 5 depicts the XPS spectra of C1s dendrimer modification from MNPs-G2.

FIG. 6 depicts (a) TEM-EDX micrograph of MNPs-G2@Cu²⁺ nanoinitiators (NCs). The transmission electron microscopy-energy-dispersive X-ray (TEM-EDX) sample was prepared on nickel (Ni) grid to observe the location of copper; vibrating-sample magnetometer (VSM) of MNPs (b) before and after modification with dendrimer; and (c) FTIR spectra of (i) polymerized triethylene glycol dimethacrylate (TRIEGMA) with MNPs-Cu²⁺ NCs; (ii) pure monomer (TRIEGMA); and (iii) polymerized TRIEGMA with Cu(OAc)₂— control system.

FIG. 7 depicts the polymerization system with different starting components: (a) TRIEGMA+tert-butyl peroxybenzoate; (b) TRIEGMA+Cu(OAc)₂; (c) tert-butyl peroxybenzoate+Cu(OAc)₂; (d) TRIEGMA+tert-butyl peroxybenzoate+Cu(OAc)₂; and (e) TRIEGMA+tert-butyl peroxybenzoate+MNPs-G2@Cu²⁺ NCs.

FIG. 8 depicts the plausible mechanism of redox-initiated radical polymerization of TRIEGMA with MNPs-G2@Cu²⁺ NCs and tert-butyl peroxybenzoate.

FIG. 9 depicts the tensile stress-strain curve of the polymerized TRIEGMA free-standing form with (a) MNPs-G2@Cu²⁺ NCs and (b) Cu(OAc)₂ as the control system; the comparison of adhesion between magnetic and control system is shown in (c) the single lap shear test from 15 samples with the presence of standard deviation on error bars; (d) the bonding area depicting the adhesion failure of MNPs-G2@Cu²⁺ adhesive after pulling apart; and (e) the schematic diagram of chemical crosslinking and physical interaction formed random entanglement, then dissipated by chain disentanglement after pulling apart.

FIG. 10 depicts the stress-strain curve of single lap shear test (15 samples) of TRIEGMA in (a) MNPs-G2@Cu²⁺ NCs; and (b) Cu(OAc)₂ control system.

FIG. 11 depicts the scheme for magnetically localized polymerization.

FIG. 12 depicts (a) the original cured polymer; (b) the magnetically induced cured polymer for 5.5 h; (c) magnetically localized polymerization with magnetically controlled co-nanoinitiators; and (d) magnetically localized polymerization after anaerobic polymerization for 5.5 h.

FIG. 13 depicts (a) TEM of magnetic microparticles (MMPs); (b) XRD of MMPs; and (c) VSM of commercial Fe₃O₄, synthesized MMPs, and synthesized MNPs.

FIG. 14 depicts (a) setup design for static patterning; and (b) resulting pattern.

FIG. 15 depicts (a) setup design for dynamic patterning; and (b) resulting pattern.

FIG. 16 depicts (a) resulting pattern after static patterning; and (b) resulting pattern after dynamic patterning.

### DESCRIPTION

It has been surprisingly found that the use of a magnetic nanocomposite material having a core of a magnetic nanoparticle that is covered with a shell bearing dendrons that chelate an initiating metal ion can be used in the formation of polymers/anaerobic adhesives in a localized manner under mild reaction conditions.

Applications for this material relate to any know application of an anaerobic adhesive and include, but are not limited to the formation of polymers/adhesives in an enclosed and confined spaces. Thus, in a first aspect of the invention, there is provided a magnetic nanocomposite material, comprising:
a core formed from a magnetic nanoparticle;
a shell surrounding the magnetic nanoparticle, which shell comprises a plurality of anchoring elements;
a plurality of dendrons, each covalently bonded to one of the anchoring elements, each dendron comprising a first non-final generation constitutional repeating unit, a plurality of final generation constitutional repeating units, where the plurality of final generation constitutional repeating units comprise a plurality of end groups, each end group comprising at least two functional groups capable of chelating to a metal ion; and
a plurality of metal ions, where each metal ion is chelated to at least one of the plurality of end groups,
wherein the plurality of metal ions is selected from one or more of the group consisting of Mn³⁺, Ce⁴⁺, Co³⁺, Cu²⁺, Fe³⁺, Cr³⁺, Mn³⁺, Ce⁴⁺, and Co³⁺.

In embodiments herein, the word “comprising” may be interpreted as requiring the features mentioned, but not limiting the presence of other features. Alternatively, the word “comprising” may also relate to the situation where only the components/features listed are intended to be present (e.g. the word “comprising” may be replaced by the phrases “consists of” or “consists essentially of”). It is explicitly contemplated that both the broader and narrower interpretations can be applied to all aspects and embodiments of the present invention. In other words, the word “comprising” and synonyms thereof may be replaced by the phrase “consisting of” or the phrase “consists essentially of” or synonyms thereof and vice versa.

The phrase, “consists essentially of” and its pseudonyms may be interpreted herein to refer to a material where minor impurities may be present. For example, the material may be greater than or equal to 90% pure, such as greater than 95% pure, such as greater than 97% pure, such as greater than 99% pure, such as greater than 99.9% pure, such as greater than 99.99% pure, such as greater than 99.999% pure, such as 100% pure.

It is to be understood the present invention is not limited to particular devices or methods, which may, of course, vary. It is also to be understood that the terminology used herein is for the purpose of describing particular embodiments only, and is not intended to be limiting. As used in this specification and the appended claims, the singular forms “a”, “an”, and “the” include singular and plural referents unless the content clearly dictates otherwise. Furthermore, the word “may” is used throughout this application in a permissive sense (i.e., having the potential to, being able to), not in a mandatory sense (i.e., must). The term “include,” and derivations thereof, mean “including, but not limited to.” The term “coupled” means directly or indirectly connected.

As will be appreciated, the magnetic nanoparticle core may be formed from any suitable material that is magnetic. Suitable materials that are magnetic include, but are not limited to, Fe, Ni, Co, Nd, Mn, Gd, Sm, Dy, alloys thereof and metallic ceramics (e.g. ferrite) thereof. In particular embodiments that may be mentioned herein, the magnetic nanoparticle may comprise one or more metals selected from the group consisting of Ni, Co, Zn, Cu, Mn, and Fe. As such, alloys and ceramics of these metals are contemplated for use as the magnetic nanoparticle. In yet more particular embodiments of the invention, the magnetic nanoparticle may be formed from Fe.

The magnetic nanoparticles used as the core, around which a second material forms a shell, may have any suitable size. For example, the magnetic nanoparticles may have a size of from 5 to 50 nm, such as from 5 to 25 nm or they may have a size of from 100 to 600 nm, such as from 200 to 390 nm.

As will be appreciated, the resulting magnetic nanocomposite material will have a diameter larger than that of the core magnetic nanoparticles. This is because the magnetic nanocomposite material has a shell material surrounding the core and then a plurality of dendrons attached to this shell. Thus, the magnetic nanocomposite material may have a diameter of from:
(ai) 5 to 50 nm, such as from 6 to 50 nm, such as from 8 to 30 nm; or
(aii) 200 to 500 nm, such as from 210 to 450 nm, such as from 220 to 400 nm.

Any suitable material that can be used to form a coating over the magnetic nanoparticles and is then capable of providing (or being adapted to provide) a plurality of anchoring elements can be used as the shell that surrounds the magnetic nanoparticle. In embodiments that may be mentioned herein, the shell may be a silica shell. Said silica shell may be made by any suitable starting material (e.g. tetraethyl orthosilicate, or tetraethoxysilane).

The shell material, no matter the material used, should be able to provide an anchoring element for the growth of a plurality of dendrons. The shell material may inherently contain suitable anchoring elements, or it may be reacted further to provide such elements. When used herein, the term “anchoring element” is used to refer to a moiety that is covalently bonded to both the shell material and at least one of the plurality of dendrons. An example of a suitable moiety that may be used as an anchoring element includes, a material that has a linear or branched C₁ to C₁₀ alkyl chain substituted by one or more amino groups. For example, the anchoring element may be a 3-propylamino group.

As stipulated by section “DH-1.17 dendron” of the “IUPAC nomenclature and terminology for dendrimers with regular dendrons and for hyperbranched polymers” (see https://iupac.org/recommendation/nomenclature-terminoloav-dendrimers-regular-dendrons-hyperbranched-polymers/), a Dendron is “part of a molecule with only one free valence, comprising exclusively dendritic and terminal constitutional repeating units and in which each path from the free valence to any end-group comprises the same number of constitutional repeating units”. When used herein, the “free valence” position of the Dendron refers to a first generation constitutional repeating unit's point of attachment of the Dendron to the shell material via the anchoring group.

Herein, a “first non-final generation constitutional repeating unit” refers to a constitutional repeating unit that is directly covalently bonded to the anchoring element. A “second non-final generation constitutional repeating unit” refers to a constitutional repeating unit that is attached covalently to the first non-final generation constitutional repeating unit. A “third non-final generation constitutional repeating unit” refers to a constitutional repeating unit that is attached covalently to the second non-final generation constitutional repeating unit. Further generations of non-final constitutional repeating unit may be interpreted accordingly. A “final generation constitutional repeating unit”, refers to the final portion of the dendron, which is capped by end groups. The final generation constitutional repeating unit may be any suitable generation of the constitutional repeating unit, though it cannot be the first generation constitutional repeating unit.

Any suitable number of generations of constitutional repeating units may be used in the current invention, provided that the resulting end groups can firmly chelate to the metal ions stably.

Thus, there may be from 1 to m generations of non-final constitutional repeating units, where m is from 2 to 5 (it will be appreciated that the total number of generations is m+1, as the final generation is not included in m). In embodiments that may be mentioned herein, m may be 1 to provide a plurality of G2 dendrons (dendrons having two generations of constitutional repeating units in total). Without wishing to be bound by theory, it is noted that G2-G6 (e.g. G2) dendrons disclosed herein may have a good chelation to copper (or other suitable metal) ions and function well as co-nanoinitiators for polymerisation reactions, as discussed in more detail below. Dendrons having a higher generation may not provide a strong chelation to copper (or other metal) ions because of an electrostatic repulsion cause either by the amine groups or the metal ions at the branches of the dendrons.

In embodiments of the invention that may be mentioned herein, each non-final generation constitutional repeating unit may have the fragment formula 1a or 1b:

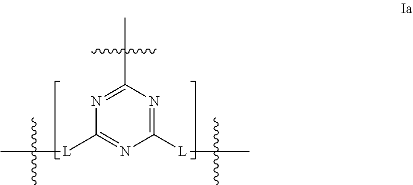

where:

the wavy lines represent the point of attachment to the rest of the molecule;

each L independently represents NR¹R² or SR³

each R¹ independently represents H or C₁ to C₆ alkyl, which C₁ to C₆ alkyl is unsubstituted;

each R² independently represents —(CHR⁴)ₙNR⁵R⁶;

each R³ independently represents —(CHR⁴)ₙSR⁷;

each R⁵ and R⁶ independently represent H, C₁ to C₆ alkyl that is unsubstituted, —(CHR⁴)ₙNR⁸R⁹, or a point of attachment to a further constitutional repeating unit or an end group;

each n independently represents 2 to 6;

each R⁸ and R⁹ independently represent H, C₁ to C₆ alkyl, which C₁ to C₆ alkyl is unsubstituted, —(CHR⁴)ₙNR¹⁰R¹¹, or a point of attachment to a further constitutional repeating unit or an end group;

each R¹⁰ and R¹¹ independently represent H, C₁ to C₆ alkyl, which C₁ to C₆ alkyl is unsubstituted, or a point of attachment to a further constitutional repeating unit or an end group;

each R⁴ represents H, OH or OR¹²; and

each OR¹² independently represents C₁ to C₃ alkyl, which C₁ to C₃ alkyl is unsubstituted; or

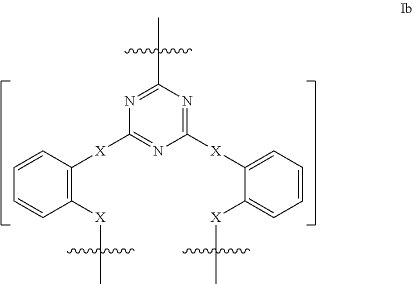

where:

each X independently represents S or NR¹³; and

each R¹³ independently represents H or C₁ to C₃ alkyl, which C₁ to C₃ alkyl is unsubstituted.

In particular embodiments of formula 1a and 1b that may be mentioned herein, each L may be selected from the list of:

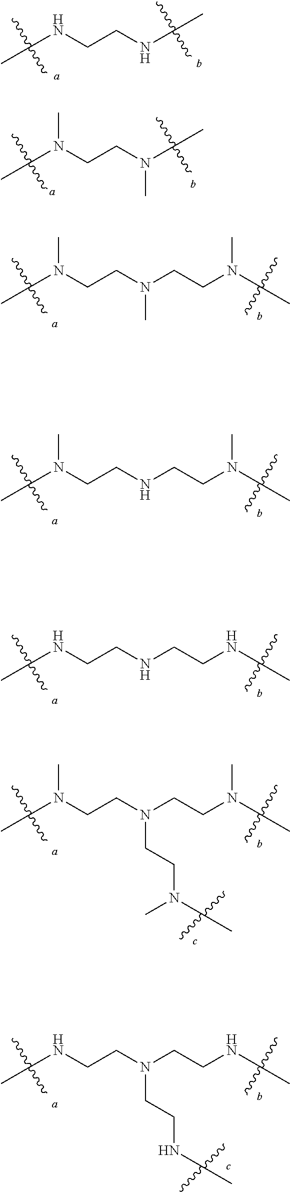

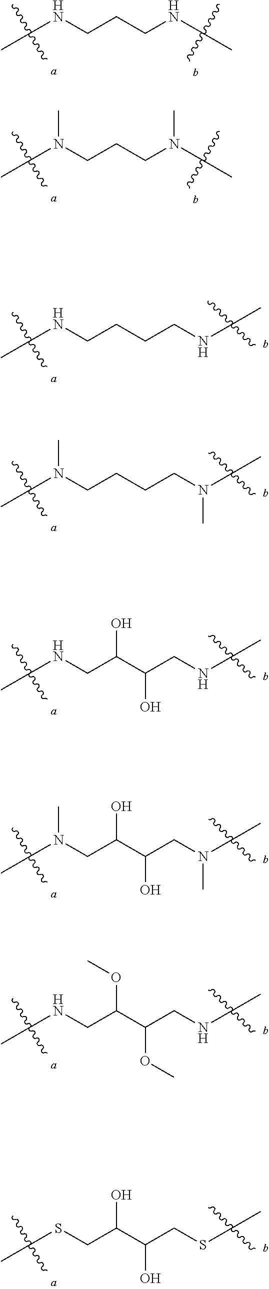

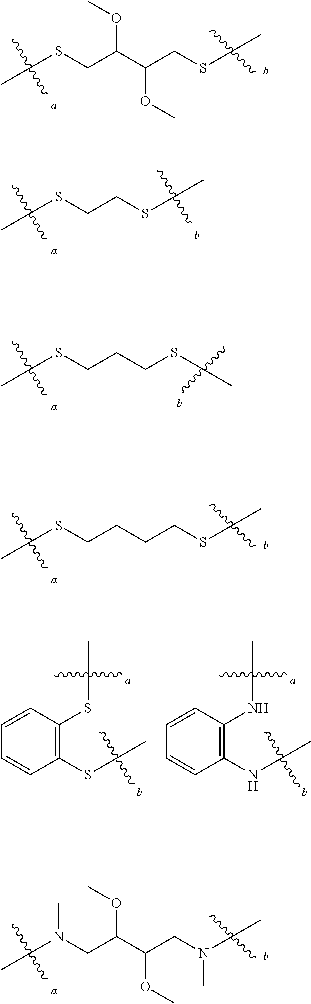

where the wavy line a represents a point of attachment to the rest of the constitutional repeating unit and the wavy lines b and, when present, c represent a point of attachment to the rest of the molecule.

In more particular embodiments of formula 1a and 1b that may be mentioned herein, each L may be selected from the list of:

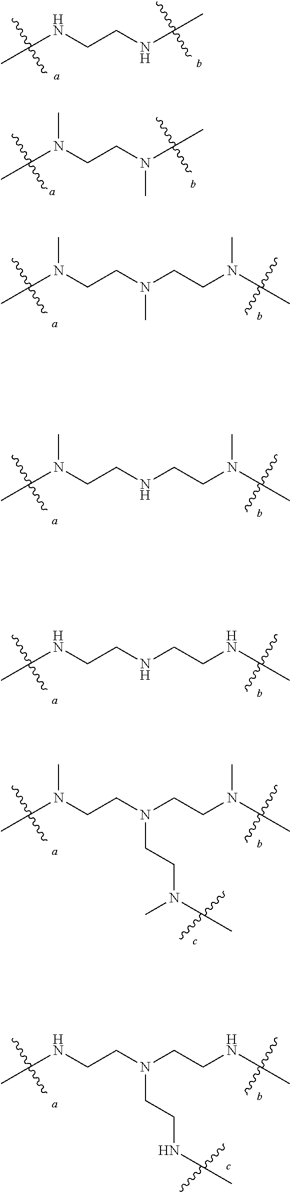

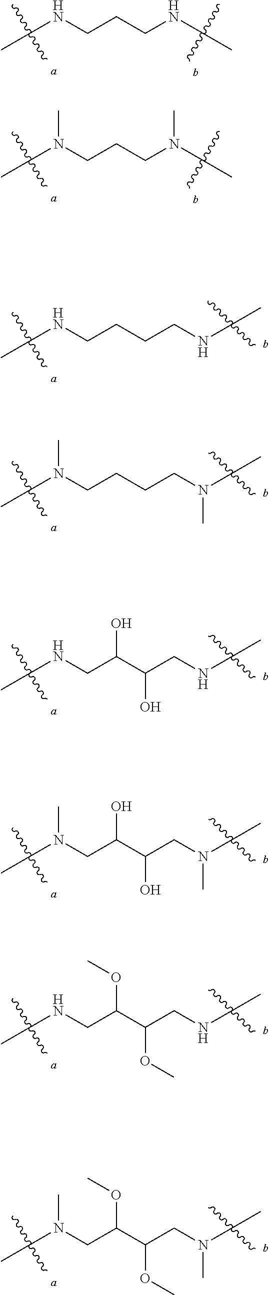

where the wavy line a represents a point of attachment to the rest of the constitutional repeating unit and the wavy lines b and, when present, c represent a point of attachment to the rest of the molecule.

For example, in formula 1a and 1b, each L may be selected from the list of:

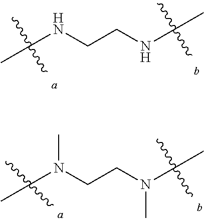

where the wavy line a represents a point of attachment to the rest of the constitutional repeating unit and the wavy line b represents a point of attachment to the rest of the molecule.

In embodiments of the invention that may be mentioned herein, each final generation constitutional repeating unit comprising a plurality of end groups may have the fragment formula 1a′ or 1b′:

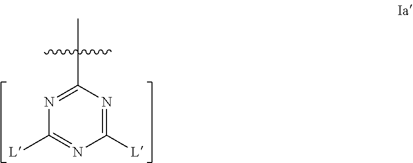

where:

the wavy line represents the point of attachment to the rest of the molecule;

each L′ independently represents an end group selected from NR^{1′}R^{2′} or SR³;

each R^{1′} independently represents H or C₁ to C₆ alkyl, which C₁ to C₆ alkyl is unsubstituted;

each R² independently represents —(CHR^{4′})ₙNR^{5′}R^{6′};

each R^{3′} independently represents —(CHR⁴)ₙSR^{7′};

each R^{5′} and R^{6′} independently represent H, C₁ to C₆ alkyl that is unsubstituted, —(CHR⁴)ₙNR^{8′}R^{9′};

each n independently represents 2 to 6;

each R^{8′} and R^{9′} independently represent H, C₁ to C₆ alkyl, which C₁ to C₆ alkyl is unsubstituted, —(CHR^{4′})ₙNR¹⁰R¹¹;

each R^{10′} and R^{11′} independently represent H, C₁ to C₆ alkyl, which C₁ to C₆ alkyl is unsubstituted;

each R^{4′} represents H, OH or OR^{12′}; and

each OR^{12′} independently represents C₁ to C₃ alkyl, which C₁ to C₃ alkyl is unsubstituted; or

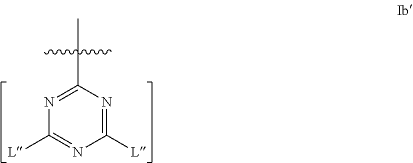

where:

the wavy line represents the point of attachment to the rest of the molecule;

each L″ independently represents an end group of formula 1c′:

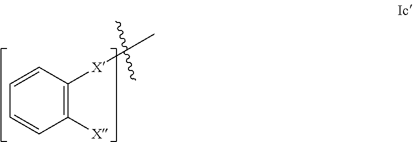

where:

the wavy line represents the point of attachment to the rest of the molecule;

each X′ independently represents S or NR¹³;

each X″ independently represents SR¹⁴ or NR^{15′}R^{16′}; and

each R^{13′} to R^{16′} independently represents H or C₁ to C₃ alkyl, which C₁ to C₃ alkyl is unsubstituted.

In particular embodiments of formula 1a′ and 1b′ that may be mentioned herein, each end group may be selected from the list of:

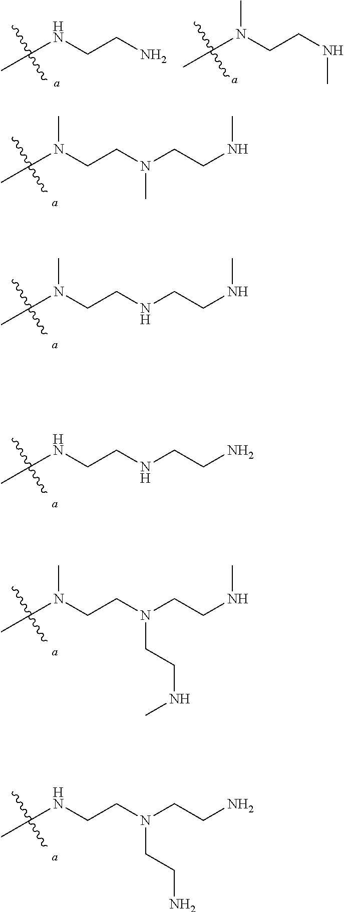

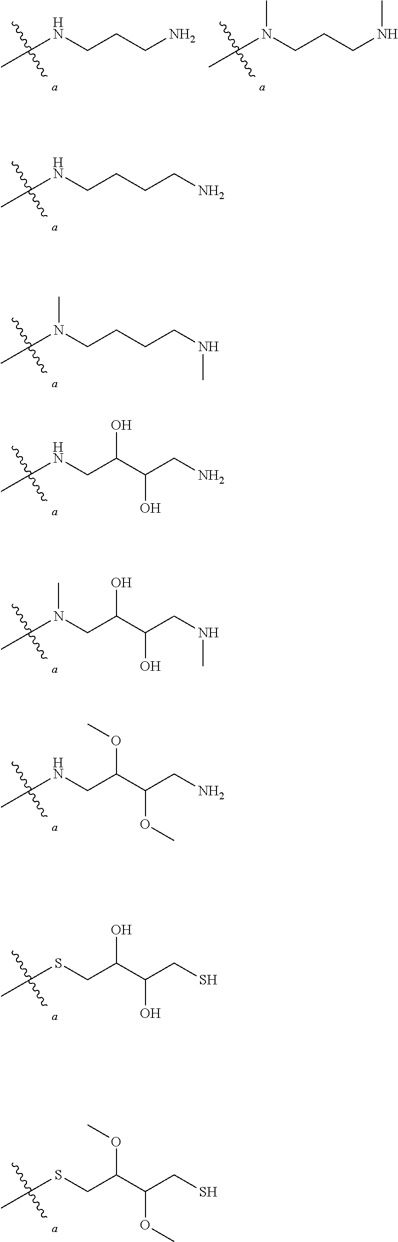

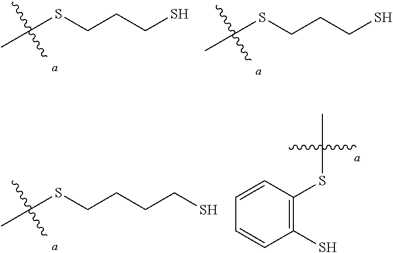

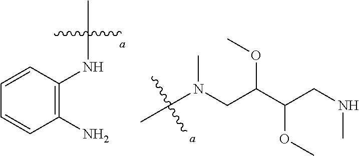 [SMILES: *Nc1ccccc1N ; *N(C)CC(OC)C(CNC)OC]

where the wavy line a represents a point of attachment to the rest of the final generation constitutional repeating unit.

In particular embodiments of formula 1a′ and 1b′ that may be mentioned herein, each end group may be selected from the list of:

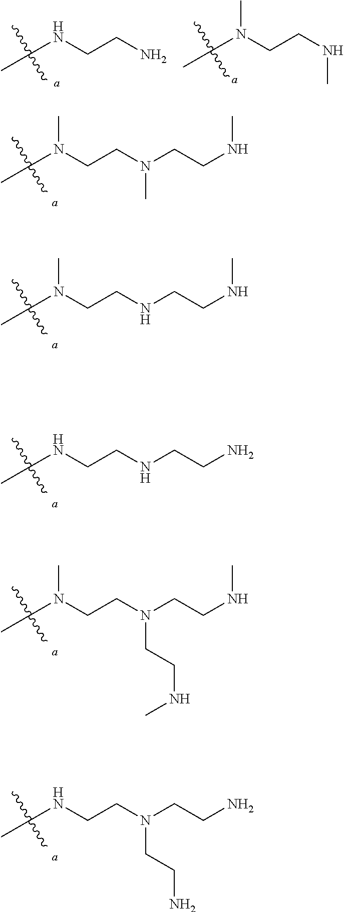

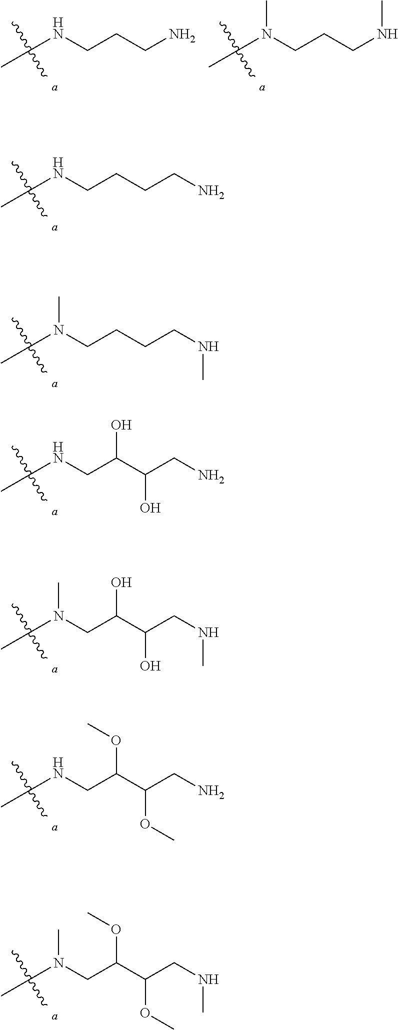

where the wavy line a represents a point of attachment to the rest of the final generation constitutional repeating unit.

For example, in embodiments of formula 1a′ and 1b′ that may be mentioned herein, each end group may be selected from the list of:

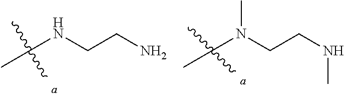

where the wavy line a represents a point of attachment to the rest of the constitutional repeating unit.

As noted above, a plurality of metal ions also form part of the magnetic nanocomposite material, where each metal ion is chelated to at least one of the plurality of end groups. Said metal ions may be selected from one or more of the group consisting of Mn³⁺, Ce⁴⁺, Co³⁺, Cu²⁺, Fe³⁺, Cr³⁺, Mn³⁺, Ce⁴⁺, and Co³⁺. More particularly, the metal ions may be selected from one or more of the group consisting of Cu²⁺, Fe³⁺, Cr³⁺, Mn³⁺, Ce⁴⁺, and Co³⁺. Yet more particularly, the plurality of metal ions may be Cu²⁺.

The magnetic nanocomposite material many also be referred to herein as MNPs-GX@M^{y+}, where MNPs stands for magnetic nanoparticles, GX stands for the total number of generations of constitutional repeating units in the magnetic nanocomposite material, M stands for the metal ion chelated to the end groups and y+represents the charge of said metal ion. For example, MNPs-G2@Cu²⁺ refers to a magnetic nanocomposite material having two total generations of constitutional repeating units where a Cu²⁺ ion is chelated to the end groups.

Advantages associated with the magnetic nanocomposite material may include:
The magnetic nanoparticles (MNPs) can be uniformly tailored and controlled the morphology such as size and shape with physical and chemical resistance properties.
The surface of MNPs can be chemically tuned by further modifications to expand various functionalities on bare MNPs.
The dendrimer ligand on MNPs enables one to firmly secure the copper (or other metal) ions by intermolecular force, particularly electrostatic force, for controlling the motion of copper to selective area.

The magnetic nanocomposite material may be particularly useful in the formation of a polymeric material (e.g. as a co-initiator of polymerisation). As such, in a further aspect of the invention, there is provided a polymeric product comprising:
a polymeric matrix formed from at least one monomeric material having a vinyl group; and
a magnetic nanocomposite material as described hereinbefore.

As will be appreciated, the magnetic nanocomposite material may be distributed within the polymeric matrix that it has been used to help generate. Details of how this may be achieved will be discussed in more detail in relation to the method of formation of the polymeric product below.

The polymeric product may be formed using any suitable monomer or combination of monomers where the magnetic nanocomposite material can be used as a co-initiator. For example, the monomers may be a material that includes a carbon-to-carbon double bond. Examples of such materials include, but are not limited to vinyl chloride, propylene, vinyl acetate, vinylidene chloride, styrene, acrylonitrile, tetrafluoroethylene, isoprene, butadiene, chloroprene, N-isopropylacrylamide, 2-hydroxyethyl methacrylate (HEMA), methyl methacrylate, ethylene glycol dimethacrylate, vinyl methacrylate, allyl methacrylate, 3-(acryloyloxy)-2-hydroxypropyl methacrylate, a dimethacrylate monomer, triethylene glycol dimethacrylate, and combinations thereof. In particular embodiments of the invention that may be mentioned herein, the monomer may be triethylene glycol dimethacrylate.

The polymeric product formed using the magnetic nanocomposite material described herein may have one or more of the following properties:
(bi) a tensile strength of from 1 to 20 MPa, such as from 8 to 15 MPa, such as from 10 to 12 MPa;
(bii) a Young's Modulus of from 10 to 300 MPa, such as from 15 to 20 MPa, such as 18 MPa, such as from 10 to 30 kPa, such as from 15 to 20 kPa, such as about 18 kPa; and
(biii) a toughness of from 0.10 to 0.50 MJ/m³, such as from 0.30 to 0.40 MJ/m³, such as 0.40 MJ/m³, such as from 250 to 500 kJ/m³, such as from 300 to 400 kJ/m³, such as 374 kJ/m³.

As described in the experimental section below, a tensile test of anaerobic polymer initiated by MNPs-G2@Cu²⁺ was conducted to compare the mechanical properties with a control system. From this test, the following advantages for the polymeric system can be derived, and it is expected that similar results would be obtained using the other magnetic nanocomposite materials discussed herein.
The mechanical parameters from the tensile test are presented in the experimental section below. It is noteworthy that the MNPs-G2@Cu²⁺ polymerization system showed a remarkable improvement of Young's modulus, toughness, and tensile strength (stress), while elongation (strain) was relatively consistent compared with the control system.
MNPs-G2@Cu²⁺ chemically impacted the polymerization system as nanofillers for tailoring the intrinsic property besides co-nanoinitiators. Moreover, different loading amounts of MNPs-G2@Cu²⁺ affect the mechanical properties of the resulting polymer.
As shown in the examples below, MNPs-G2@Cu²⁺ significantly promoted the enhancement of radical species from peroxide through the redox reaction, resulting in a stronger entanglement of the polymer chains.
The presence of MNPs-G2@Cu²⁺ effectively reinforced the mechanical properties of the polymer as they appear to act as nanofillers and result in denser chemical crosslinking and increasing physical interactions.

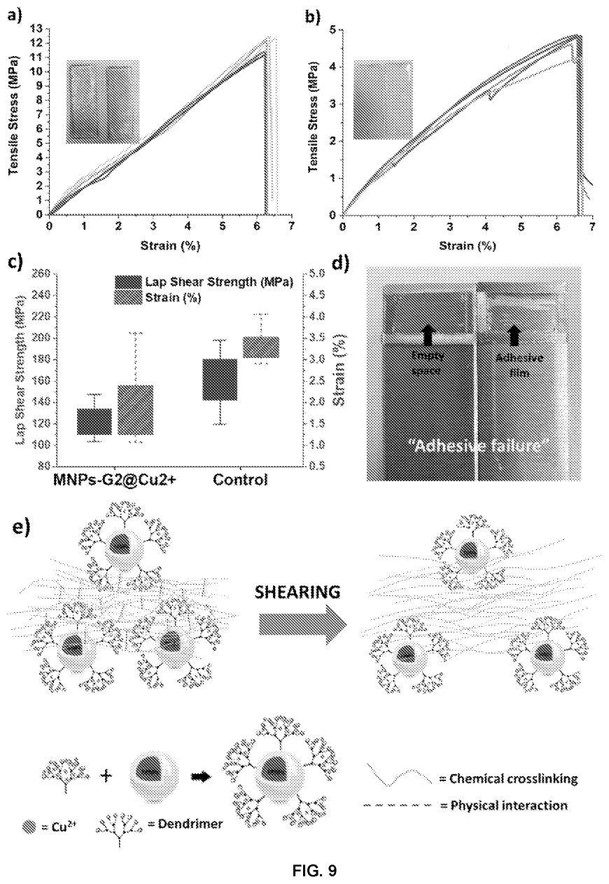

In addition, the interfacial adhesion of cured TRIEGMA was carried out by using single lap shear strength test to evaluate the adhesive property (see examples). The MNPs-G2@Cu²⁺ and control adhesive systems were physically secured to a surface under deoxygenated reaction conditions (as discussed in the experimental section and further below). The adhesive strength of the control and the MNPs-G2@Cu²⁺ system were measured and analyzed from 15 samples.
a) MNPs-G2@Cu²⁺ adhesive system provided higher crosslinking density (brittle property). Therefore, breaking at strong lap shear strength with short elongation was found at the breaking point.
b) The MNPs-G2@Cu²⁺ adhesive sample (FIG. 9d) demonstrated adhesion failure. The physical interactions, including H-bond, electrostatic interaction, or London dispersion were broken.
c) Cohesive force (covalent crosslinking) of the MNPs-G2@Cu²⁺ adhesive was stronger than interfacial interaction on the substrate, corresponding to lower single lap shear strength.
d) Adhesiveness was affected by the incorporation of MNPs-G2@Cu²⁺. However, the maximum lap shear strength of MNPs-G2@Cu²⁺ adhesive is higher or comparable to dimethacrylate adhesives in research literature and in commercial products.

It will be appreciated that the magnetic nanocomposite material disclosed herein may be pre-packaged for use with a suitable monomer (or mixture of monomers. As such, in a further aspect of the invention, there is provided a formulation comprising:
at least one monomeric material having a vinyl group; and
a magnetic nanocomposite material as described hereinbefore.

In this formulation, the monomer may be selected from one or more of the group consisting of vinyl chloride, propylene, vinyl acetate, vinylidene chloride, styrene, acrylonitrile, tetrafluoroethylene, isoprene, butadiene, chloroprene, N-isopropylacrylamide, 2-hydroxyethyl methacrylate (HEMA), methyl methacrylate, ethylene glycol dimethacrylate, vinyl methacrylate, allyl methacrylate, 3-(acryloyloxy)-2-hydroxypropyl methacrylate, a dimethacrylate monomer, and triethylene glycol dimethacrylate. For example, the monomer may be triethylene glycol dimethacrylate.

As mentioned above, the magnetic nanocomposite materials disclosed hereinbefore may be particularly useful in the formation of a polymeric material. In particular, a localized formation of the polymeric material at a desired site.

In a further aspect of the invention, there is provided a method of forming a polymeric material, the method comprising:
(ci) forming a mixture in a vessel comprising:
   at least one monomeric material having a vinyl group
   a magnetic nanocomposite material according as described hereinbefore; and
   a peroxide to form a mixture: and
(cii) allowing the mixture to form the polymeric material over a period of time.

It is believed that the localized redox-initiated radical polymerization was magnetically induced by the synergistic function of initiators between the magnetic nanocomposite material (e.g. MNPs-G2@Cu²⁺) and peroxide. It is noticeable that the polymerization was necessarily promoted in the presence of a metal ion (e.g. Cu²⁺) source. It is also noted that the redox reaction between the metal ions in the end groups (e.g. Cu(II) and Cu(I) of magnetic responsive MNPs-G2@Cu²⁺) locally enhanced the decomposition of radical species from peroxide species to achieve the successful polymerization. This is demonstrated most clearly when the reaction is conducted in the presence of one or more magnets, which attracts the magnetic nanocomposite material and sets up a concentration gradient of peroxide radicals in the reaction mixture, which is discussed in more detail below.

As will be appreciated, the localised polymerisation feature is optional and may, or may not be used. As such, the use of magnets may be optional. However, if there is a desire to control the site of formation of the polymeric material, then this may be accomplished through the use of one of more magnets, such that the polymerization occurs at one or more desired regions of the vessel.

The vessel referred to herein may be any suitable vessel. This may be an inanimate object (e.g. inside a pipe or other hand-to-reach location) or, in some cases, a living subject in need of formation of a polymeric material at a particular location due to a specific treatment need.

It is noted that formation of the mixture at ambient temperature may be sufficient to cause the polymerisation to occur. However, if initiation of the polymerisation does not occur, or is proceeding too slowly, then heat may be applied to the mixture. For example, the mixture may be subjected to an activation by the application of heat to the mixture. Any suitable temperature may be applied such as from 20 to 100° C., such as from 25 to 75° C., such as from 30 to 60° C., such as from 40 to 50° C.

For the avoidance of doubt, when a nested set of numerical ranges is disclosed herein it is explicitly contemplated that any combination of the values listed may be used as the upper and lower end of the range. Thus, for the temperature values listed above, the following ranges are explicitly contemplated:
from 20 to 25° C., from 20 to 30° C., from 20 to 40° C., from 20 to 50° C., from 20 to 60° C., from 20 to 75° C., from 20 to 100° C.;
from 25 to 30° C., from 25 to 40° C., from 25 to 50° C., from 25 to 60° C., from 25 to 75° C., from 25 to 100° C.;
from 30 to 40° C., from 30 to 50° C., from 30 to 60° C., from 30 to 75° C., from 30 to 100° C.;
from 40 to 50° C., from 40 to 60° C., from 40 to 75° C., from 40 to 100° C.;
from 50 to 60° C., from 50 to 75° C., from 50 to 100° C.;
from 60 to 75° C., from 60 to 100° C.; and
from 75 to 100° C.

When a magnet is used in the method, any suitable magnet may be used. For example, the magnet(s) employed herein may be made from the materials discussed hereinbefore for use in the magnetic nanoparticles or they may be an electromagnet.

When magnet(s) are used in the polymerisation method, the magnetic nanocomposite material dispersed within the mixture in the vessel will be attracted towards the magnet(s). This means that the magnetic nanocomposite material becomes concentrated in area(s) close to a magnet.

Without wishing to be bound by theory, it is believed that, as the magnetic nanocomposite material interacts with the peroxide source to form peroxide radicals, the concentration of the magnetic nanocomposite material in area(s) close to a magnet results in a concentration gradient of peroxide radicals within the mixture, with the highest concentration of peroxide radicals being closest to the area(s) in the vessel close to a magnet and an increasingly lower concentration the further from a magnet that one travels. Given that the peroxide radicals initiate the polymerisation reaction, the highest concentration of polymers would be expected to occur closest to the area(s) affected by a magnet, while little or no polymer would be expected to be formed in areas that are not affected by a magnetic field. This effect may be seen, for instance, in FIG. 11. TRIEGMA peroxide 111 may be mixed with MNPs-G2@Cu²⁺ 112 in a petri dish. A magnet 113 may be applied to induce magnetically localized polymerization to give polymerized monomer 114. Less- or un-polymerized monomer 115 may be formed as it is not exposed to the magnet 113, and it can be removed using an organic solvent. Thus, the generation of the polymeric material can be directed to a desired area, which may be hard to reach or be otherwise inaccessible by conventional means (e.g. in a pipe).

As noted previously, the method of polymerisation may be conducted in the absence of oxygen (e.g. under a suitable inert atmosphere, such as nitrogen or argon).

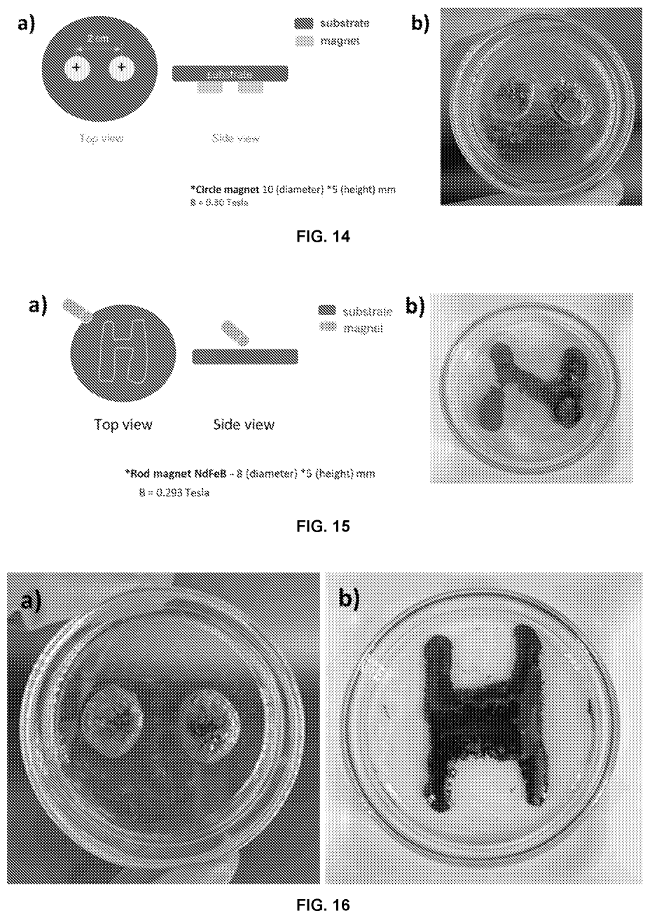

As will be appreciated, the magnets may be static or moving dynamically. As such, in embodiments where the one or more magnets are moved in a pattern, the resulting polymeric material may conform to the pattern provided by the one or more magnets. This is demonstrated in Examples 12-13 and FIG. 14-15. In embodiments of the invention where such a dynamic pattern is desired to be formed the diameter of the magnetic nanocomposite material may be from 200 to 500 nm, such as from 210 to 450 nm, such as from 220 to 400 nm.

In embodiments where the one or more magnets are statically placed and the polymeric material may form at an area of the vessel corresponding to the location of the one or more magnets. In embodiments of the invention where a static pattern is desired to be formed the diameter of the magnetic nanocomposite material may be from 5 to 100 nm, such as from 6 to 50 nm, such as 8 to 30 nm.

Applications of the technology disclosed herein may relate to equipment that needs to be sealed (e.g. military and civilian personal protective equipment), in the electronics industry (e.g. to adhere a heat sink to a processing in need thereof), in medicine (e.g. to seal a wound), in the pipeline industry (e.g. to seal a leak), in the aerospace, automotive and rail industries (e.g. to act as a glass sealant in engine components; as a thread locking adhesive, and the like).

An example of a magnetic composite material that may be used herein is the core-shell is the second-generation magnetic nanoparticles carrying Cu²⁺ ions (MNPs-G2@Cu²⁺). As described in the examples below that was successfully formed and served as a magnetic responsive co-nanoinitiator and nanofiller.

The synthesis procedures and combination of anaerobic adhesive polymerization system are as following:
1. The preparation of core magnetic nanoparticles (MNPs)
   a) Iron chloride (FeCl₃·6H₂O) and sodium oleate dissolved in ethanol (EtOH), DI water, and hexane to obtain the Fe-oleate complex.
   b) The Fe-oleate complex was refluxed the reaction at 70° C. for 4 hours.
   c) The Fe-oleate precursor is repeatedly extracted with DI water and evaporated to remove solvent in the system.
   d) The Fe-oleate precursor is mixed with oleic acid (OA) surfactant in 1-octadecene at room temperature in the ratio of 36:5.7: 200 by weight.
   e) The reaction was heated to 320° C. with 3.3° C./min ramp rate and holding for 30 min under inert condition.
   f) The resulting brownish black sample is centrifuged and purified by hexane and iso-propanol.
   g) The uniformed MNPs are re-dispersed in cyclohexane and stored in the fridge.

It will be appreciated that any other suitable fatty acid and solvents may be used in the above described process, which is intended as a guide to the manufacture of such materials.
2. The method of statement 1, wherein the source of metal can change to other transition metal elements such as Ni, Co, Zn, Cu, Mn, etc. As will be appreciated, a similar synthetic approach can be used to form other core magnetic nanoparticles based on the materials too.
3. The method of statement 1 or 2, wherein the morphology (size, and shape) can be tuned by the refluxing time of precursor, and the heating temperature, ramp rate, together with reaction time under inert condition.
4. The method of any one of statements 1 to 3, wherein the solvent for re-dispersed uniformed MNPs can be another non-polar solvent such as hexane, chloroform, toluene, pentane, etc.
5. The preparation of core-shell magnetic-dendrimer modification (MNPs-G2)
   a) Igepal CO-520 (a non-ionic surfactant) and anhydrous cyclohexane were well-mixed for 10 min.
   b) 25% ammonium hydroxide (NH₄OH) was gradually added before adding MNPs into the solution.
   c) Tetraethyl orthosilicate (TEOS) was dropwised into the solution and stirred for 16 hours at room temperature.
   d) The resulting core-shell MNPs@SiO₂ NPs were purified and centrifuged and re-dispersed in ethanol.
   e) The mixture of core-shell MNPs@SiO₂ NPs and 3-aminopropyltriethoxysilane (APS) in H₂O and EtOH (1:1) was stirred for 8 hours at room temperature.
   f) The resulting MNPs-APS (NH₂) was purified and centrifuged with ethanol.
   g) MNPs-APS NPs in cyanuric chloride (CC), and trimethylamine were mixed in THF and stirred for 10-14 hour to obtain MNPs-CC1.
   h) MNPs-CC1 in DMF, ethylenediamine, and triethylamine were mixed at 60° C. for 12-14 hour to obtain MNPs-G1.
   i) Step g) and h) were repeated to achieve MNPs-CC2 and MNPs-G2, respectively.
   j) MNPs-G2 was purified and centrifuged with hot ethanol.

It will be appreciated that this method may be adapted to suit the other products described herein.
6. The preparation of core-shell MNPs-G2@Cu²⁺ co-nanoinitiators
   a) The dispersion of MNPs-G2 in DMF was mixed with Cu(OAc)₂ and stirred for 6 hour.
   b) The suspension of MNPs-G2@Cu²⁺ in dark green colour was subsequentially washed with acetone and stored in the fridge. 7. The method of statement 6, wherein the copper salt can be other counter ions such as BF₄₋, OTf₄₋, Cl⁻, etc.

It will be appreciated that the process above for the formation of the final product can be adapted to use the other metal ions as described hereinbefore that are suitable for this purpose.
8. The combination of anaerobic adhesive polymerization system
   a) Triethylene glycol dimethacrylate (TRIEGMA), tert-butyl peroxybenzoate (98% peroxide), and copper (II) source were mixed for using as polymerization system.
   b) The polymerization of a) was preferably triggered under anaerobic condition.

As will be appreciated the monomer and peroxide source may be varied, as discussed hereinbefore.

Further aspects and embodiments of the invention will now be discussed by reference to the following non-limiting embodiments.

### EXAMPLES

Materials

All chemicals were purchased from Sigma-Aldrich. No purification of the chemicals was carried out before use. The steel substrates (Q-Panel, RS-14) for single lap shear test that fulfilled the requirement of ASTM D1002, were purchased from Q-Lab.

Analytical Techniques

TEM-EDX

TEM (JEOL 2010 UHR, Japan) was equipped with EDX detector to image the morphology and investigate the elemental components of MNPs before and after surface modification. The dispersion of sample was drop-cast onto nickel grid for imaging and running EDX.

XRD analysis

XRD was performed by Pananalytical XRD (Cu-Kα radiation operated at 40 kV and 30 mA) to reveal the phase of MNPs compared with JCPDF database. Powder sample was prepared on the zero-background holder before the XRD experiment was run.

FTIR Spectroscopy

The FTIR spectra of the modified MNPs were obtained by PerkinElmer FTIR Frontier spectrometer. FTIR was performed to check the functional groups on the MNPs after each modification step.

XPS

XPS analysis was performed using an AXIS Supra spectrometer (Kratos Analytical, UK) equipped with a hemispherical analyzer (monochromatic Al K-alpha source (1487 eV) operated at 15 kV and 15 mA) to detect elemental components and the chemical environment on the surface of the materials. The samples were prepared by drop casting of the dispersion on indium tin oxide (ITO)-coated glass.

Inductively Coupled Plasma Mass Spectrometer (ICP-MS)

Perkin Elmer (model Elan-DRC-e) was employed to measure the concentration of elements in the sample dispersion.

TGA

TGA (Q500) was utilized to investigate the thermal stability of the sample, with a rate 10° C./min under N₂ flow from 30-700° C.

Elemental Analysis (EA)

The organic moiety from carbon, nitrogen, hydrogen was analyzed by using EA (Elementar Vario EL Ill model, CHNS elemental analyzer).

VSM

The magnetization was measured at room temperature (RT) using a 8600 Series (Lake Shore Cryotronics) VSM.

### Example 1

Spherical MNPs (25-30 nm) were synthesized via a thermal decomposition method developed by Park et al. (J. Park et al., Nat. Mater. 2004, 3, 891-895).

Briefly, an iron-oleate precursor was prepared by refluxing a reaction of iron chloride (FeCl₃19 6H₂O, 2.16 g) and sodium oleate (7.30 g) dissolved in ethanol (EtOH, 16 mL), deionized (DI) water (12 mL), and hexane (28 mL). The solution was heated to 70° C. for 4 h. The iron-oleate precursor was purified by extraction with DI water several times, and the solvents were removed in vacuo. The iron-oleate precursor was obtained as a waxy form.

Then, a reaction mixture of iron-oleate precursor:oleic acid (OA):1-octadecene=36:5.7:200 by weight were mixed at RT. The reaction was heated to 320° C. with a constant rate of 3.3° C. min⁻¹, and holding for 30 min under inert condition with the use of Schlenk technique. The reaction mixture began to boil and form particles, and turbid and brownish black solids were observed in the solution. After the resulting solution with MNPs was cooled down to RT, hexane and i-propanol were used to precipitate the MNPs. The MNPs were separated by centrifugation and re-dispersed in cyclohexane to give pristine MNPs.

### Example 2

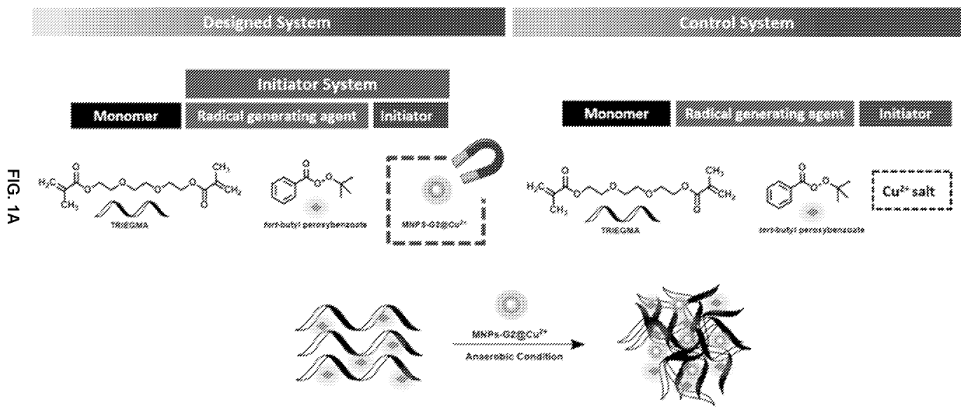

MNPs-G2@Cu²⁺ NCs were designed according to the concept of core-shell structure, as illustrated in FIG. 1b.

MNPs@—SiO₂

To improve the functionality of the pristine MNPs prepared in Example 1, silane modification was introduced to attach appropriate linkers onto the surface of the pristine MNPs. The pristine MNPs were coated with silane compounds using the following procedure.

Igepal CO-520 (9.88 g) and anhydrous cyclohexane (90 mL) were stirred together for 10 min. Basic ammonium hydroxide (1.50 mL, 25%, NH₄OH) solution was gradually added to the reaction mixture and was mixed well. After that, pristine MNPs (90 mg) were added into the reaction mixture. Tetraethyl orthosilicate (TEOS, 600 mL) was added dropwise into the reaction mixture and it was stirred for 16 h at RT. The resulting core-shell MNPs@SiO₂ NPs were purified by washing and centrifuging with EtOH, and re-dispersing in EtOH. By doing so, a silica shell with an approximate thickness of 5-6 nm was coated on MNPs.

MNPsDNH₂

To modify amine group onto MNPs@SiO₂ NPs, 3-aminopropyltriethoxysilane (APS) was used as the coupling agent. MNPs@SiO₂ core-shell NPs (30 mg) were dispersed well in a mixture of water and EtOH (1:1) by sonication before adding APS (50 μL). The reaction mixture was stirred continuously for 8 h at RT. The resulting MNPs-APS NPs were purified with EtOH and separated by centrifugation. Then, MNPs@APS (MNPs@NH₂) was re-dispersed and sonicated in tetrahydrofuran (THF) for modification in further steps.

To promote the surface functionality, dendrimer ligands were grafted onto MNPs-APS NPs.

MNPs-CC1

Cyanuric chloride (1.85 g, CC), and trimethylamine (1.40 mL) were dissolved in THF. Subsequently, MNPs-APS (2 g) was dispersed in the reaction mixture to initiate the amine coupling reaction. The reaction mixture was stirred for 10 h to give MNPs-CC1. The resulting MNPs-CC1 were centrifuged and purified with hot THF several times.

MNPs-Generation 1 (MNPs-G1)

A dispersion of MNPs-CC1 (1 g) in DMF (12 mL), ethylenediamine (en, 0.53 mL) and triethylamine (TEA, 1.1 mL) were mixed at 60° C. for 12 h to give MNPs-generation 1 (MNPs-G1). The resulting MNPs-G1 were centrifuged and purified with hot EtOH several times.

MNPs-CC2

MNPs-CC2 was prepared from MNPs-G1 (1 g) by following the protocol for MNPs-CC1 except CC (1.66 g) and TEA (1.2 mL) in THF (20 mL) were used, and the reaction mixture was stirred for 14 h.

MNPs-Generation 2 (MNPs-G2)

MNPs-G2 was prepared from MNPs-CC2 (1 g) by following the protocol for MNPs-G1 except en (0.63 mL) and TEA (1.3 mL) in DMF (20 mL) were used, and the reaction mixture was stirred for 60° C. for 14 h.

MNPs-G2(Cu²⁺

MNPs-G2 was covalently coordinated with copper(II) (Cu²⁺) through the addition of copper(II) acetate (Cu(OAc)₂) at the end of the dendrimer branches. A dispersion of MNPs-G2 (0.5 g) in DMF (10 mL) was mixed with Cu(OAc)₂ (0.09 g) and stirred for 6 h. The suspension of MNPs-G2@Cu²⁺ was subsequentially centrifuged and washed with acetone. Dark green MNPs-G2@Cu²⁺ was then obtained. The resulting MNPs-G2@Cu²⁺ was stored in the fridge. The copper content of MNPs-G2@Cu²⁺ was measured with ICP-MS prior to use.

### Example 3

The materials prepared in Examples 1 and 2 were taken for characterization studies.

Results and Discussion

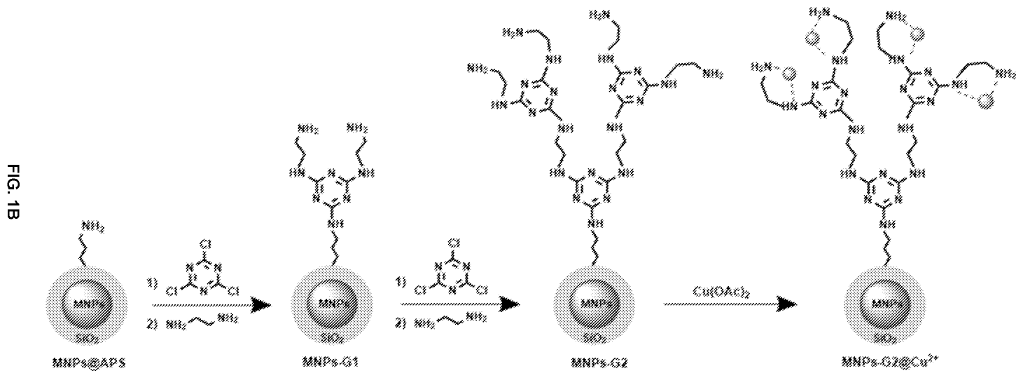

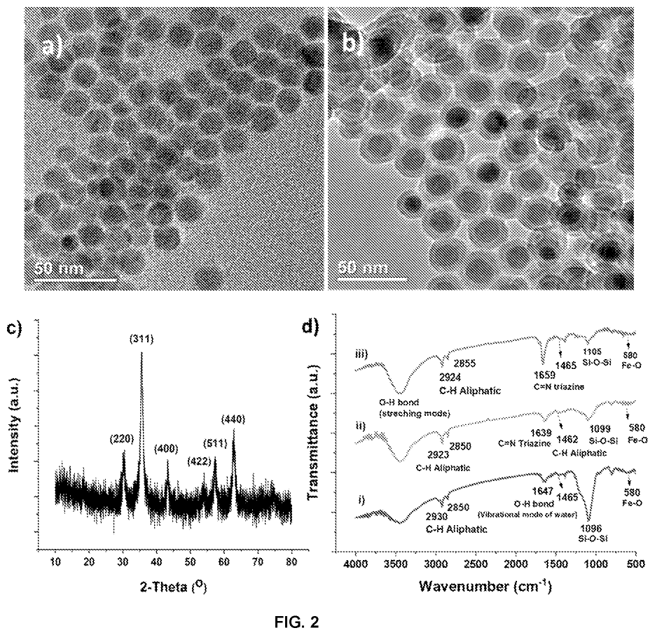

The well-dispersed spherical and pristine MNPs with a diameter range of 15-21 nm were confirmed by the high-resolution TEM micrograph as depicted in FIG. 2a. The XRD pattern (FIG. 2c) of the synthesized MNPs corresponded to (220), (311), (400), (422), (511), and (440), which matched well with the magnetite (Fe₃O₄; JCPDS no. 85-1436) crystal structure. Therefore, the MNPs can be uniformly tailored, and the morphology such as size and shape can be controlled.

The surface of the pristine MNPs were modified with silane through selective coating of TEOS on the MNPs surface (MNPs@SiO₂) to enhance the functionality and improve chemical stability. FIG. 2b illustrates the uniform coating of silica shell on the magnetic core with an approximate thickness of 6 nm. The core-shell magnetic silica structure was further examined with FTIR spectroscopy. The FT-IR spectrum of MNPs@APS (FIG. 2d) reveals a broad signal of O—H symmetrical and asymmetrical stretching vibration bands at 3300-3400 cm⁻¹. The vibration mode of the physically absorbed moisture on the surface of the materials was also found at 1647 cm⁻¹. The bonding information of silica shell was confirmed by the existence of Si—O—Si strong absorption band at ˜1096 cm⁻¹ (A. L. Isfahani et al., Adv. Synth. Catal. 2013, 355, 957-972; and M. Hegazy et al., Polym. Chem. 2017, 8, 5852-5864). Importantly, the characteristic bands of C—H aliphatic bond at ˜1462 and ˜2930 cm⁻¹ provided strong evidence of APS modification of the core-shell structure. Besides the mentioned signals on the FT-IR spectra, triazine signal (C═N), which is ascribed to the triazine moieties (H. Yan et al., RSC Adv. 2015, 5, 18538-18545; and K. Bahrami & M. S. Arabi, New J. Chem. 2016, 40, 3447-3455) on MNPs, was found in both MNPs-G1 and MNPs-G2 spectra at ˜1639, and ˜1659 cm-1, respectively. Moreover, the intensity ratio of C═N and Si—O—Si in MNPs-G2 was relatively higher than in MNPs-G1, which can be attributed to the growth of G2 dendrimer on MNPs.

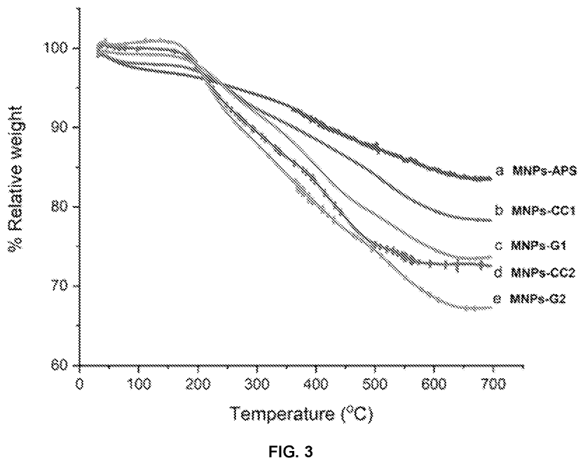

To examine the organic moieties from dendrimer modification at each generation, TGA and EA characterization were carried out. The TGA and EA characterization evidently supported the sequence of dendrimer growth from G1 to G2 (FIG. 3 and Tables 1-2). According to TGA analysis, the decomposition of organic moieties on MNPs were increased at each generation of dendrimer growth (M. Nasr-Esfahani et al., J. Mol. Catal. A: Chem. 2013, 379, 243-254; and Y. Wang et al., J. Mater. Chem. B 2013, 1, 5028-5035). In accordance with EA, the amount of organic weight loss (C, H, and N) from MNPs-G2 was in a good agreement with the detected organic content from TGA.

TABLE 1
Moiety of organic compounds on MNPs analyzed by TGA.

| Sample | Organic (wt %) | Organic (mmol/g MNPs) | Yield (%) |
|---|---|---|---|
| MNPs-APS | 15.43 | 2.66 | — |
| MNPs-CC1 | 20.63 | 1.00 | 38 |
| MNPs-G1 | 25.45 | 1.00 | 100 |
| MNPs-CC2 | 26.60 | 0.49 | 49 |
| MNPs-G2 | 32.67 | 0.51 | 104* |

*Percent yield of MNPs-G2 is higher than 100 because of the presence of water molecules on surface of materials as depicted in FIG. 3.

TABLE 2
Moiety of organic components (C, H,
N) from MNPs-G2 analyzed by EA.

| | | | | Total |
|---|---|---|---|---|
| Sample | % C | % H | % N | % weight loss |
| MNPs-G2 | 19.31 | 2.24 | 9.09 | 30.64 |

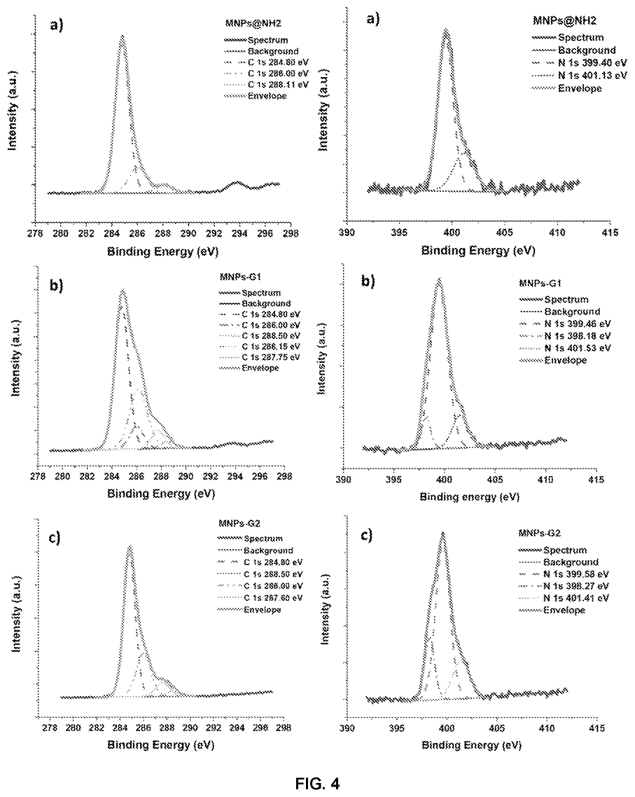

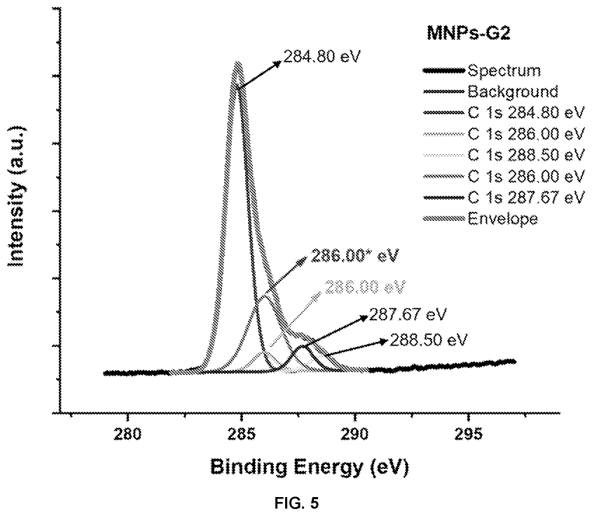

To further prove the sequence of dendrimer growth on the MNPs surface, MNPs-APS, MNPs-G1, and MNPs-G2 samples were analyzed by XPS as illustrated in FIG. 4. The XPS spectra of C1s, and N1s provided substantial details of dendrimer modifications. The C1s envelope of MNPs@APS (—NH₂) consisted of characteristic binding energy from amines (C—N) at around 286.00 eV, which confirmed amine modification on MNPs. A trace of adventitious carbon contamination (O—C═O, N—C═O) was detected at 288.11 eV (F. Ekiz et al., J. Mater. Chem. 2011, 21, 12337-12343), which is commonly exposed on surface of materials (ThermoFisher Scientific, https://xpssimplified.com/periodictable.php, 2020). For G1 modification, the presence of protonated amines (C—NH³⁺), carbon atoms in triazine ring (G. Yang et al., Polymer 2010, 51, 6193-6202), and adventitious carbon (O—C═O, N—C═O, ThermoFisher Scientific, https://xpssimplified.com/periodictable.php, 2020) were exhibited at around 286.15 eV, 287.75 eV, and 288.50 eV, respectively. The slightly broader signal at 286.00 eV in C1s of the MNPs-G2 spectra was ascribed to the integration of the amines signal with the protonated amines signal after further introduction of the G2 dendritic structure (FIG. 5, E. Roeven et al., ACS Omega 2019, 4, 3000-3011). In accordance with the chemical environment from N1s spectra, the spectra of MNPs@APS, MNPs-G1, and MNPs-G2 showed contribution of amine (R—NH₂, 399 eV) and protonated amines (R—NH³⁺, ˜401 eV) signals (H. Hlidkove et al., Macromolecules 2017, 50, 1302-1311). Meanwhile, the additional signal of sp²-hybridized N (C—N═C) around 398 eV (R. M. Yadav et al., New J. Chem. 2020, 44, 2644-2651; and Z.-H. Hei et al., RSC Adv. 2016, 6, 92443-92448), which is the characteristic binding energy of triazine ring, was corroborated to both MNPs-G1 and MNPs-G2 spectra. Further, the successful modification of dendritic structure from G1 to G2 was confirmed by the higher N/C intensity ratio of triazine ring and the ratio of N (triazine, ˜398 eV)/N (dendrimer branches —NH₂, ˜399 eV) from G1 to G2 modification on the MNPs (FIG. 4b-c).

XPS calculations:

The XPS peak area ratio of N/C (triazine) from MNPs-G1=437/1370=0.32 The XPS peak area ratio of N/C (triazine) from MNPs-G2=1084/1514=0.72

The XPS peak area ratio of N (triazine)/N (branch) from MNPs-G1=437/4291=0.10 The XPS peak area ratio of N (triazine)/N (branch) from MNPs-G2=1084/3837=0.28 According to the higher generation of dendrimer, the number of amino groups on the terminal branches increased exponentially with each generation of growth, which allowed multiple reactive sites for self-assembly with Cu(II) via electrostatic interaction (R. K. Sharma et al., Green Chem. 2016, 18, 3184; and V. V. Narayanan & G. R. Newkome, in Dendrimers, Springer Berlin Heidelberg, Berlin, Heidelberg 1998, 19-77).

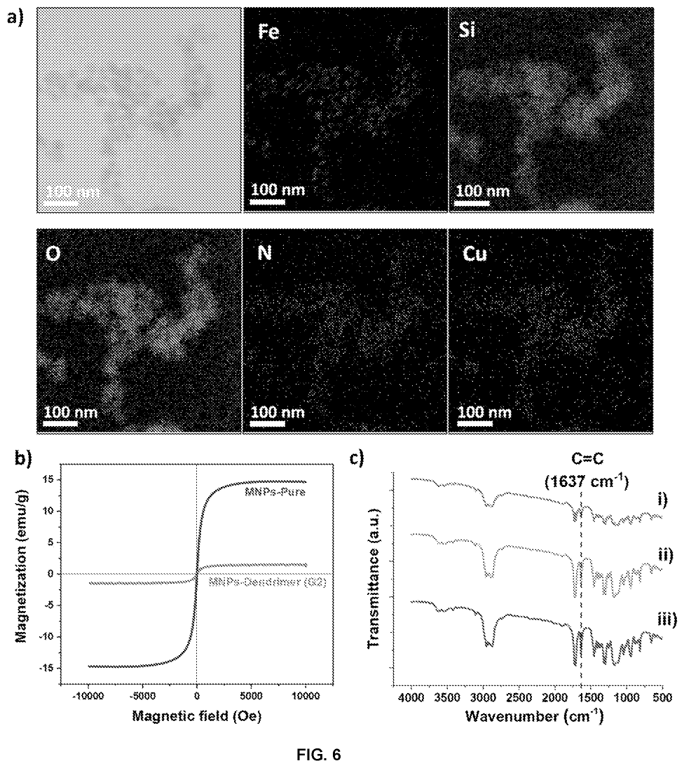

The MNPs-G2@Cu²⁺ core-shell structure was investigated by TEM-EDX. The diameter obtained after copper immobilization on MNPs-G2 was 31 nm. The dendrimer growth was evidently shown by the thicker layer compared with core-shell MNPs@APS structure. From the TEM micrograph (FIG. 6a), the immobilization of copperwas found to considerably improve the dispersion of MNPs-G2 NCs because of the electrostatic repulsion of Cu²⁺ on the dendrimer branches. Furthermore, TEM-EDX showed that the iron (Fe) content notably exhibited at the magnetic core, while silica (Si), oxygen (O), and nitrogen (N) contents were localized around the MNPs. The distribution of copper (Cu) content was evenly detected on MNPs-G2@Cu²⁺ NCs. Further, the copper content of MNPs-G2@Cu²⁺ NCs was measured by ICP-MS analysis, and was reported to be 130 mg L⁻¹ of MNPs-G2@Cu²⁺ NCs.

VSM revealed the magnetic properties of pristine MNPs and MNPs-G2@Cu²⁺ NCs (FIG. 6b). The VSM measurement was carried out at RT from −10000 Oe to +10000 Oe. The superparamagnetic behavior (J. Ge et al., Angew. Chem. Int. Ed. Engl. 2007, 46, 4342-4345; and J. Ge et al., Adv. Mater. 2010, 22, 1905-1909) was apparent in both magnetization curves. Neither coercivity nor remanence was observed. The saturation magnetization (Ms) values of pristine MNPs and MNPs-G2@Cu²⁺ NCs were 14.75 emu.g⁻¹ and 1.50 emu.g⁻¹, respectively. As expected, the reduction of Ms was attributed to the surface modification of the MNPs with silica and dendrimer, and was due to the lower magnetite fraction from individual nanoinitiators (Y. Yuan et al., Langmuir 2012, 28, 13051-13059; D. Shao et al., J. Colloid Interface Sci. 2009, 336, 526-532; and B. Asadi et al., New J. Chem. 2016, 40, 6171-6184).

Therefore, it is confirmed that MNPs-G2@Cu²⁺ NCs were successfully synthesized. The amino functional groups from dendrimer immobilized with copper content on MNPs@SiO₂ (MNPs-G2@Cu²⁺ NCs) represent an advanced nano-architecture design of catalyst and filler with a unique advantage of being magnetic field responsive.

### Example 4

The preparation of the polymerization systems is described below. The same molar equivalent of each component was used in each system. Cu(OAc)₂ was utilized as the copper source in the control systems.

TRIEGMA+tert-butyl peroxybenzoate

TRIEGMA (1.53 mmol) and tert-butyl peroxybenzoate (98% peroxide, 0.21 mmol) were mixed.

TRIEGMA+Cu(OAc)₂

TRIEGMA (1.53 mmol) and Cu(OAc)₂ (0.249 μmol) were mixed.

tert-butyl peroxybenzoate+Cu(OAc)₂

Tert-butyl peroxybenzoate (98% peroxide, 0.21 mmol) and Cu(OAc)₂ (0.249 μmol) were mixed.

TRIEGMA+tert-butyl peroxybenzoate+Cu(OAc)₂ (anaerobic adhesive control)

TRIEGMA (1.53 mmol), tert-butyl peroxybenzoate (98% peroxide, 0.21 mmol) and Cu(OAc)₂ (0.249 μmol, copper content) were mixed.

TRIEGMA+tert-butyl peroxybenzoate+MNPs-G2@Cu²⁺ (MNPs-G2(@Cu²⁺ adhesive)

MNPs-G2@Cu²⁺ adhesive was prepared from MNPs-G2@Cu²⁺ by following the protocol for 35 anaerobic adhesive control except MNPs-G2@Cu²⁺ NCs were used instead of Cu(OAc)₂. The concentration of Cu(II) on MNPs-G2@Cu²⁺ NCs was analyzed using ICP-MS.

All the polymerization systems were cured under a deoxygenated environment (in glovebox) for 24 h.

### Example 5

The performance of MNPs-G2@Cu²⁺ NCs toward redox radical polymerization was evaluated using the polymerization systems prepared in Example 4.

Results and Discussion

The polymerization of TRIEGMA monomer was initiated in the presence of MNPs-G2@Cu²⁺ NCs with tert-butyl peroxybenzoate. The direct use of Cu(OAc)₂ as the initiator was used for comparison.

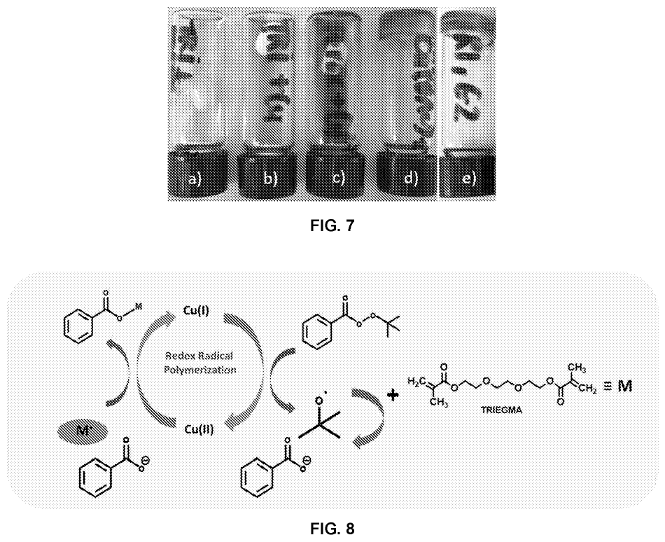

The digital images of the cured polymers in vials are depicted in FIG. 7. It is clearly shown that polymerization do not occur for combinations without a Cu source. The redox-initiated radical polymerization was necessarily promoted in the presence of a Cu source. The redox reaction between Cu(II) and copper(I) (Cu(I)) remarkably enhanced the generation of radical species from the peroxide species to effect the successful polymerization. The plausible radical production mechanism of MNPs-G2@Cu²⁺ NCs has been proposed in FIG. 8. Therefore, MNPs-G2@Cu²⁺ significantly promoted the enhancement of radical species from peroxide through the redox reaction, resulting in a stronger entanglement of polymer chains. Consequently, it is reasonable to confirm that MNPs-G2@Cu²⁺ NCs played a crucial role as co-nanoinitiators in the polymerization process. Furthermore, the results obtained prove the effectiveness of MNPs-G2@Cu²⁺ as co-nanoinitiators for redox-initiated radical polymerization despite potential steric hindrance from the supramolecular dendrimer.

### Example 6

The mechanical properties of the cured control and MNPs-G2@Cu²⁺ polymers were investigated.

Tensile Test

The MNPs-G2@Cu²⁺ and control polymerization systems in Example 4 were taken for post-cure heat treatment according to literature (D. Lascano et al., Polymers 2019, 11, 1354; and Y. H. Bagis & F. A. Rueggeberg, Dent. Mater. 2000, 16, 244-2477).

The reaction mixture of the anaerobic adhesive control and MNPs-G2@Cu²⁺ adhesive prepared in Example 4 was each cured in a rectangular-shaped Teflon mold. The polymerization occurred under deoxygenated environment (in glovebox) at RT. After that, the samples were taken for post-cure heat treatment. The samples were treated with a hot air gun (100° C.) until a freestanding form was obtained. Finally, specimens with 15 mm width, 1 mm thickness, and 10 mm initial nominal gauge length (the length between the grippers of the mechanical tester) were obtained.

The tensile stress-strain test was conducted using a mechanical tester (MTS Criterion, model 43) with a 1 kN load cell and a strain rate of 1.27 mm min⁻¹ at RT. The data were monitored and recorded in real time by a connected computer. The stress was calculated using the equation, σ=F/A, where F is the load, and A is the bonding area of the adhesive.

The strain was calculated from ε=ΔL/L, where ΔL is the elongation of the sample compared with the initial length (L) of the sample. The Young's modulus was acquired from the slope at the beginning of the stress-stain curve (linear region).

Results and Discussion

The presence of the C═C signal (1637 cm⁻¹) on the FT-IR spectra of the cured control and MNPs-G2@Cu²⁺ polymers (FIG. 6c) revealed that unreacted TRIEGMA monomer still remained after overnight polymerization. The unsaturated carbon of methacrylate-based compound could affect the mechanical properties of the polymer. Therefore, to overcome the aforementioned issue, post-cure heat treatment was carried out to maximize the mechanical properties of the cured polymers in both systems. The specimens of the cured polymer from MNPs-G2@Cu²⁺ and control polymerization system are illustrated in the inset photograph in FIG. 9a and FIG. 9b, respectively.

A tensile test on the anaerobic polymer initiated by MNPs-G2@Cu²⁺ (FIG. 9a) was conducted to compare its mechanical properties with the control system (FIG. 9b). The mechanical parameters calculated from the tensile test (FIG. 9a-b) are presented in Table 3. It is noteworthy that the MNPs-G2@Cu²⁺ polymerization system allowed a remarkable improvement in the Young's modulus, toughness, and tensile strength (stress), while elongation (strain) was relatively consistent as compared with the control system. The mechanical improvement of MNPs-G2@Cu²⁺ system was ascribed to the higher density of chemical crosslinking of the methacrylate functional group because the enhancement of the radical species from peroxide was promoted by the redox reaction of MNPs-G2@Cu²⁺, resulting in stronger entanglement of polymer chains. Reasonably, the chemical crosslinking dominantly contributed to the major mechanical improvement in Young's modulus, toughness, and tensile strength compared with the control system. Meanwhile, the physical interactions were attributed to Van Der Waals, London dispersive, hydrogen bond (H-bond), and ion-dipole interactions between the G2-dendrimer branches (amine functional group) and the polymer chains, resulting in the generation of sacrificial bonds to dissipate energy. Hence, the slight change in the tensile elongation at the breaking point suggested that strong chemical crosslinking was effectively formed, while only a small contribution to energy dissipation was observed. Moreover, the presence of MNPs-G2@Cu²⁺ in the polymerization system provided high tensile strength with the restriction of elongation, which indicates characteristic behavior of thermoset (D. Lascano et al., Polymers 2019, 11, 1354) and this is due to the fact that the major TRIEGMA component has a thermoset property (rigid polymer after curing). For this reason, the nature of the resulting polymer will remain brittle at the elongation break, while the rest of mechanical properties were improved. Thus, the use of MNPs-G2@Cu²⁺ is effective as co-nanoinitiators and as nanofillers, which strengthened the mechanical performance of the polymer via denser chemical crosslinking and physical interactions.

TABLE 3
Mechanical parameters calculated from tensile test represented in FIG. 9a-b.

| | Young's | Toughness | Tensile | Elongation |
|---|---|---|---|---|
| Sample | modulus (MPa) | (MJ · m⁻³) | strength (MPa) | at break (%) |
| TRIEGMA - Cu(OAc)₂ | 62.64 ± 0.06 | 0.15 ± 8.07 | 4.70 ± 0.37 | 6.78 ± 0.13 |
| TRIEGMA - MNPs-G2@Cu²⁺ | 181.42 ± 0.04 | 0.37 ± 7.70 | 12.00 ± 1.18 | 6.00 ± 0.15 |

### Example 7

The interfacial adhesion of cured TRIEGMA was carried out by using single lap shear strength test to evaluate the adhesive property.

Single Lap Shear Adhesion Test

The surface of the stainless-steel substrates (25 mm width×102 mm length x 2 mm thickness) was cleaned with iso-propanol for surface pre-treatment. To control the thickness of the adhesive (160-170 μm) between the adherends, the stainless-steel substrate was framed by double-sided tape on the rough side. The reaction mixture of the anaerobic adhesive control and MNPs-G2@Cu²⁺ adhesive prepared in Example 4 was each applied onto the bonding area (20 mm width×13 mm length) which was secured with a clip. The panels were treated overnight under deoxygenated environment (in glovebox) without elevating temperature applied. The lap shear test was conducted by using a mechanical tester (MTS Criterion, model 43) with a 1 kN load cell and a strain rate of 1.27 mm min⁻¹ at RT.

Results and Discussion

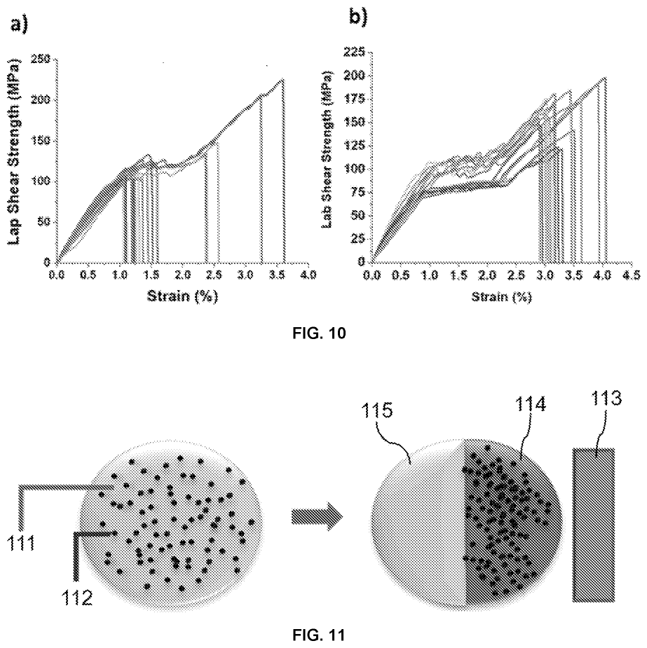

The bonding area between the adherends of both systems (MNPs-G2@Cu²⁺ and control) were physically secured under deoxygenated condition at 24 h polymerization time, without a trace of wet adhesive leftover. Typically, the inert species generated via redox-radical polymerization are suppressed by the active metal surface, resulting in better polymerization at RT under deoxygenated condition. According to FIG. 9c, the adhesive strength of the control and MNPs-G2@Cu²⁺ system was measured and analyzed from 15 samples. The maximum lap shear strength obtained from the control and MNPs-G2@Cu²⁺ systems was 164 MPa and 117 MPa, respectively. The saw-tooth appearance of the stress-strain curve (FIG. 10b) was attributed to the poorer uniformity of adhesive bonding of the control compared with MNPs-G2@Cu²⁺ adhesive system (FIG. 10a). Moreover, strain-hardening was detected from the stress-strain curves of the control adhesive during the lap shear strength measurement, suggesting that the covalent crosslinking was further deformed across the elastic barrier, and necking behavior was therefore detected.

FIG. 9c shows that the strain of the control system was extensively longer at certain stress compared with MNPs-G2@Cu²⁺ adhesive system. The strain of the control and MNPs-G2@Cu²⁺ systems was 3.18% and 1.37%, respectively. Thus, the polymer from the control system has larger stretchability than that from the MNPs-G2@Cu²⁺ adhesive system. This is because the MNPs-G2@Cu²⁺ adhesive system provided higher crosslinking density. Therefore, the breaking at strong lap shear strength with short elongation was found at the breaking point, which corresponded to the brittle property observed in the tensile test in Example 6. Consequently, the slope of the stress-strain curve increased constantly without strain-hardening until failure was detected. With reference to the different behaviors of lap shear strength, the results obtained provided strong evidence to prove that MNPs-G2@Cu²⁺ has chemically impacted the polymerization system as co-nanoinitiators, and as nanofillers for tailoring the intrinsic property of the polymer. The MNPs-G2@Cu²⁺ adhesive sample (FIG. 9d) demonstrated adhesion failure, where the failure occurred between the adhesive and the substrate. This reflects that the physical interactions, including H-bond, electrostatic interaction, and London dispersion forces, were broken following the suggested mechanism in FIG. 9e. In other words, the cohesive force (covalent crosslinking) of MNPs-G2@Cu²⁺ adhesive was stronger than the interfacial interaction on the substrate, corresponding to lower single lap shear strength. The maximum lap shear strength of MNPs-G2@Cu²⁺ adhesive obtained is not as high as the control adhesive but it is higher or comparable to the dimethacrylate adhesives in existing research or commercial products, and it does not require complicated compositions in the polymerization systems.

### Example 8

The magnetic field induced localized polymerization of the MNPs-G2@Cu²⁺ adhesive prepared in Example 4 was evaluated.

Magnetically Localized Polymerization

The polymerization of TRIEGMA monomer was magnetically initiated in the presence of MNPs-G2@Cu²⁺ with tert-butyl peroxybenzoate (FIG. 11).

Results and Discussion

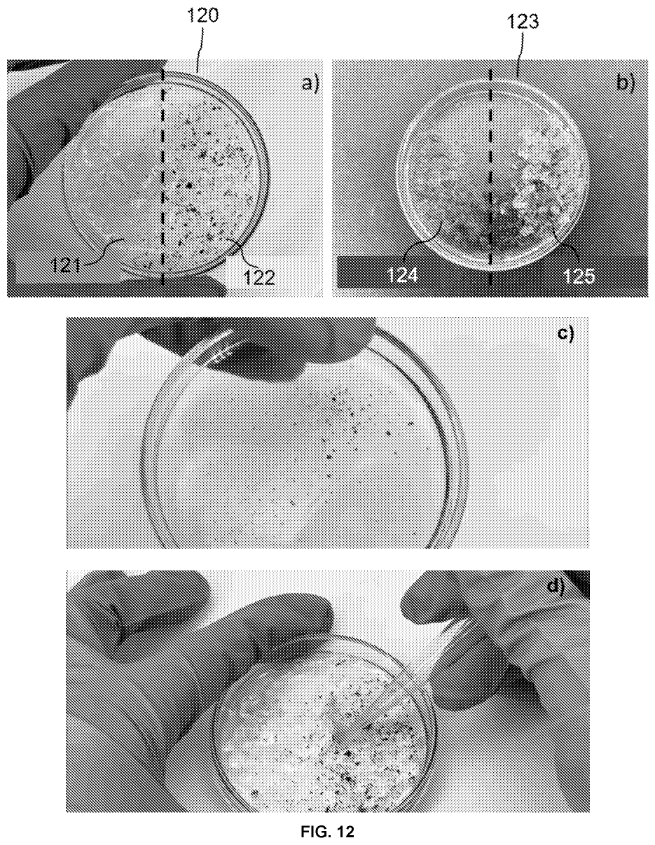

The localized redox-initiated radical polymerization was magnetically induced by the synergistic function of initiators between MNPs-G2@Cu²⁺ and peroxid, as depicted in FIG. 12a-b. FIG. 12a depicts a photograph of the original cured polymer 120 with unpolymerized monomer 121 and polymerized monomer 122 formed. FIG. 12b depicts a photograph of the magnetically induced cured polymer for 5.5 h 123 with unpolymerized monomer 124 and polymerized monomer 125 formed. It is noticeable that the polymerization was necessarily promoted in the presence of Cu source. The redox reaction between Cu(II) and Cu(I) of magnetic responsive MNPs-G2@Cu²⁺ locally enhanced the decomposition of radical species from peroxide species to achieve the successful polymerization.

### Example 9

MMPs were prepared and developed from the original method by Zhao et al. (Zhao, Y. et al., Chem. Eng. J. 2014, 235, 275-283).

FeCl₃·6H₂O (1.35 g, 2.5 mmol) was fully dissolved in ethylene glycol (40 mL), followed by the addition of polyethylene glycol (PEG-4000, 1.0 g), sodium acetate (3.6 g), and trisodium citrate (0.72 g). The reaction mixture was stirred vigorously at 70° C. for 1-2 h until it was completely homogeneous. The resulting mixture was sealed in Teflon-lined stainless-steel autoclaves, and heated to 200° C. for 8 h in the oven. The resulting black reaction mixture was washed several times with DI water and EtOH, and dried at 60° C. in the vacuum oven to obtain bare MMPs as a black or brownish powder.

### Example 10

The surface of the bare MMPs prepared in Example 9 was modified by following the protocols in Example 2.

MMPs@SiO₂

MMPs@SiO₂ was prepared from bare MMPs by following the protocol for MNPs@SiO₂.

MMPs-G2

MMPs-G2 was prepared from bare MMPs by following the protocol for MNPs-G2.

MMPs-G2@Cu²⁺

MMPs-G2@Cu²⁺ was prepared from MMPs-G2 by following the protocol for MNPs-G2@Cu²⁺.

### Example 11

The materials prepared in Examples 9 and 10 were taken for characterization studies.

Results and Discussion

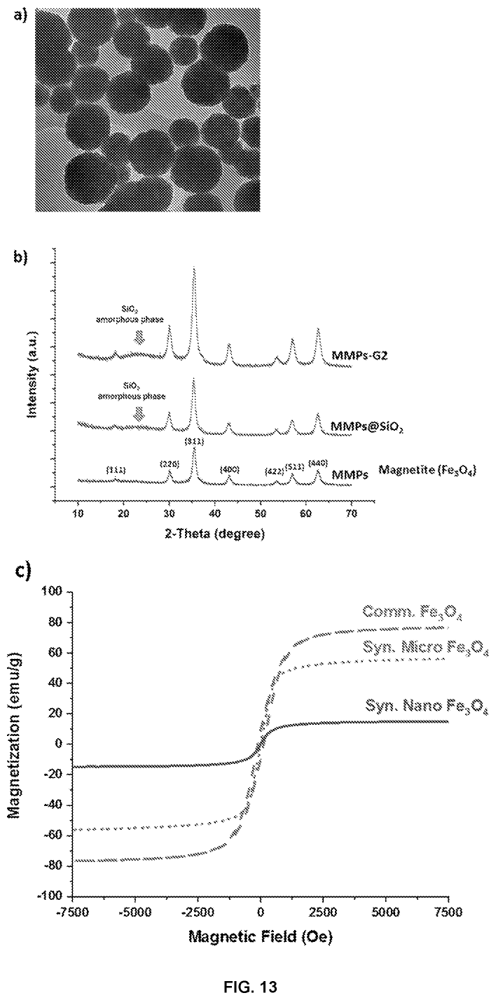

The bigger size (250±23 nm) of MMPs was shown by TEM micrograph (FIG. 13a) with the phase confirmation of Fe₃O₄ by XRD pattern (FIG. 13b). Comparing between MNPs and MMPs, the permeability of MMPs was also improved, as shown in FIG. 13c. We expected that the bigger core magnetic particles will realize the external magnetic field better than the smaller magnetic particles because of the higher magnetic permeability. Indeed, FIG. 13c supports our hypothesis. In doing so, MMPs can potentially be utilized as an effective core magnetic initiator, as will be demonstrated in the following examples.

### Example 12

Magnetic patterning (static patterning) studies were carried out on a MMPs-G2@Cu²⁺ and TRIEGMA polymerization system.

MMPs-G2@Cu²⁺+TRIEGMA

TRIEGMA (2.40 mL), tert-butyl peroxybenzoate (98% peroxide, 240 μL), and MMPs-G2@Cu²⁺ (prepared in Example 10, 0.249 μmol copper content) were mixed under inert condition in a glovebox.

Magnetic Patterning (Static Patterning)

The pattern was created by using a circular magnet under the petri dish/substrate, as shown in the setup design in FIG. 14a. The localized polymerization was therefore magnetically initiated in the circular shape pattern after elevating the temperature to 40-50° C. for 5-10 min under inert condition. The unpolymerized and less polymerized portion around the circular magnetic pattern was removed by ethanol.

Results and Discussion

FIG. 14b shows the pattern after static patterning.

### Example 13

Magnetic patterning (dynamic patterning) studies were carried out on the MMPs-G2@Cu²⁺ and TRIEGMA polymerization system prepared in Example 12.

Magnetic Patterning (Dynamic Patterning)

The pattern was created by using a permanent magnet to draw the on-demand pattern under the petri dish/substrate, as shown in the setup design in FIG. 15a. The magnetic nanoinitiators were centralized in the middle of the substrate using the magnetic field. After that, the permanent magnet was subsequently applied to create the dynamic pattern. The pattern was created by drawing the magnetic nanoinitiators on the substrate. The localized polymerization was therefore selectively initiated, following the pattern of the magnetic alignment after elevating the temperature to 40-50° C. for 3 min under inert condition. The unpolymerized and less polymerized portion around the circular magnetic pattern was removed by ethanol.

Results and Discussion

FIG. 15b shows the pattern after dynamic patterning.

### Example 14

A prepolymer system was developed to be more viscous than the TRIEGMA monomer since we believe that a prepolymer with higher viscosity can secure the magnetic pattern better than TRIEGMA monomer which has lower viscosity. Magnetic static and dynamic patterning were carried out as described in Examples 12 and 13, respectively.

Prepolymer System

A prepolymer was prepared from HEMA (4000 μL), TRIEGMA (90 μL), peroxide (210 μL), copper(II) tetrafluoroborate (Cu(BF₄)₂, 2140 μL), and ethylene glycol (15 mL) under inert condition at 60-70° C. for 4 min.

Results and Discussion

A static pattern was seen after placing the substrate above circular magnet for 10 min under inert condition at 40-50° C. (FIG. 16a). FIG. 16b illustrates the dynamic pattern after polymerization for 3 min under inert condition at 40-50° C.

1. A magnetic nanocomposite material, comprising:
a core formed from a magnetic nanoparticle;
a shell surrounding the magnetic nanoparticle, which shell comprises a plurality of anchoring elements;
a plurality of dendrons, each covalently bonded to one of the anchoring elements, each dendron comprising a first non-final generation constitutional repeating unit, a plurality of final generation constitutional repeating units, where the plurality of final generation constitutional repeating units comprise a plurality of end groups, each end group comprising at least two functional groups capable of chelating to a metal ion; and
a plurality of metal ions, where each metal ion is chelated to at least one of the plurality of end groups,
wherein the plurality of metal ions is selected from one or more of the group consisting of Mn³⁺, Ce⁴⁺, Co³⁺, Cu²⁺, Fe³⁺, Cr³⁺, Mn³⁺, Ce⁴⁺, and Co³⁺.

2. The magnetic nanocomposite material according to claim 1, wherein the magnetic nanoparticle comprises one or more metals selected from the group consisting of Fe, Ni, Co, Nd, Mn, Gd, Sm and Dy.

3. (canceled)

4. The magnetic nanocomposite material according to claim 1, wherein the shell is a silica shell.

5. The magnetic nanocomposite material according to claim 1, wherein the plurality of anchoring elements comprise a linear or branched C₁ to C₁₀ alkyl chain substituted by one or more amino groups.

6. The magnetic nanocomposite material according to claim 1, wherein each non-final generation constitutional repeating unit has the fragment formula 1a or 1b: 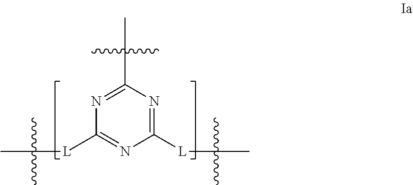
where:
the wavy lines represent the point of attachment to the rest of the molecule;
each L independently represents NR¹R² or SR³ each R¹ independently represents H or C₁ to C₆ alkyl, which C₁ to C₆ alkyl is unsubstituted;
each R² independently represents —(CHR⁴)ₙNR⁵R⁶;
each R³ independently represents —(CHR⁴)ₙSR⁷;
each R⁵ and R⁶ independently represent H, C₁ to C₆ alkyl that is unsubstituted, —(CHR⁴)ₙNR⁸R⁹, or a point of attachment to a further constitutional repeating unit or an end group;
each n independently represents 2 to 6;
each R⁸ and R⁹ independently represent H, C₁ to C₆ alkyl, which C₁ to C₆ alkyl is unsubstituted, —(CHR⁴)ₙNR¹⁰R¹¹, or a point of attachment to a further constitutional repeating unit or an end group;
each R¹⁰ and R¹¹ independently represent H, C₁ to C₆ alkyl, which C₁ to C₆ alkyl is unsubstituted, or a point of attachment to a further constitutional repeating unit or an end group;
each R⁴ represents H, OH or OR¹²; and
each OR¹² independently represents C₁ to C₃ alkyl, which C₁ to C₃ alkyl is unsubstituted; or 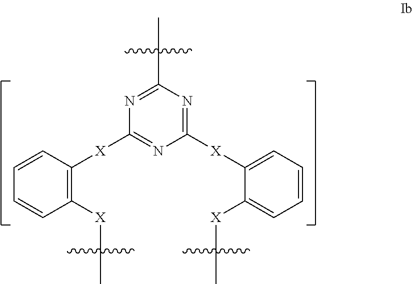
where:
each X independently represents S or NR¹³; and
each R¹³ independently represents H or C₁ to C₃ alkyl, which C₁ to C₃ alkyl is unsubstituted.

7. The magnetic nanocomposite material according to claim 6, wherein each L is selected from the list of: 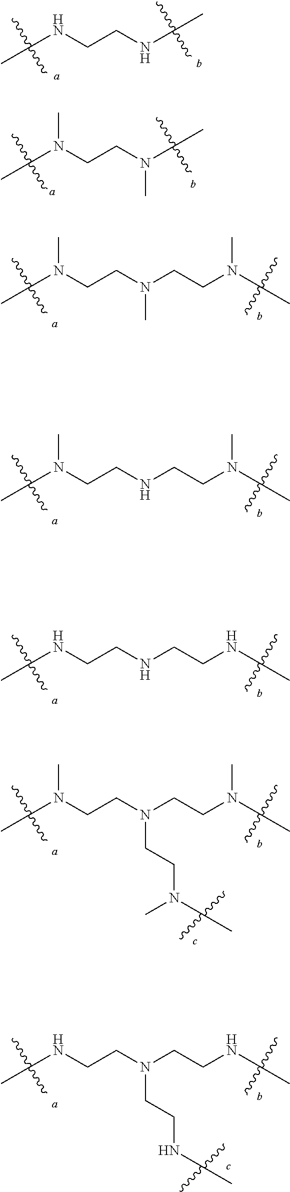 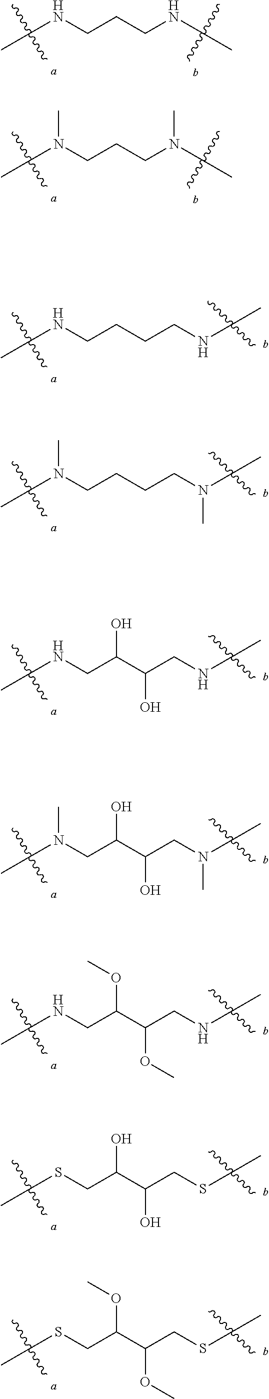 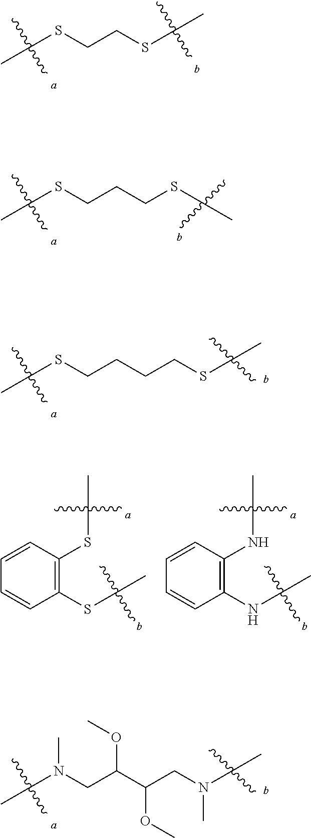 [SMILES: *SCCS* ; *SCCCS* ; *SCCCCS* ; *Sc1ccccc1S* ; *Nc1ccccc1N* ; *N(C)CC(OC)C(CN(*)C)OC]
where the wavy line a represents a point of attachment to the rest of the constitutional repeating unit and the wavy lines b and, when present, c represent a point of attachment to the rest of the molecule.

8. The magnetic nanocomposite material according to claim 7, wherein each L is selected from the list of: 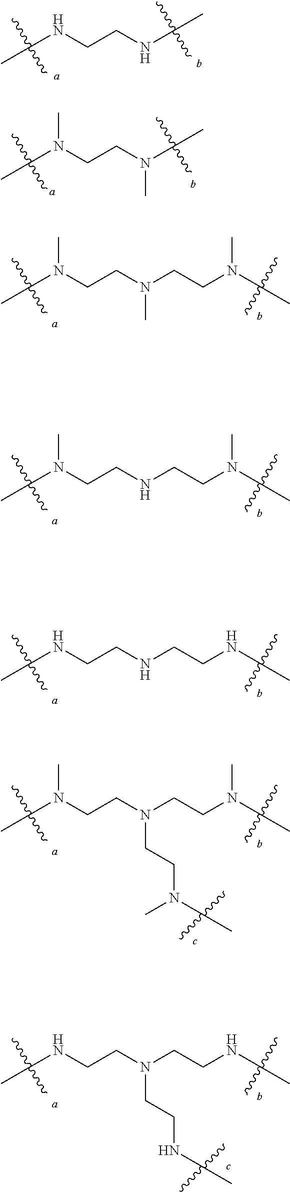 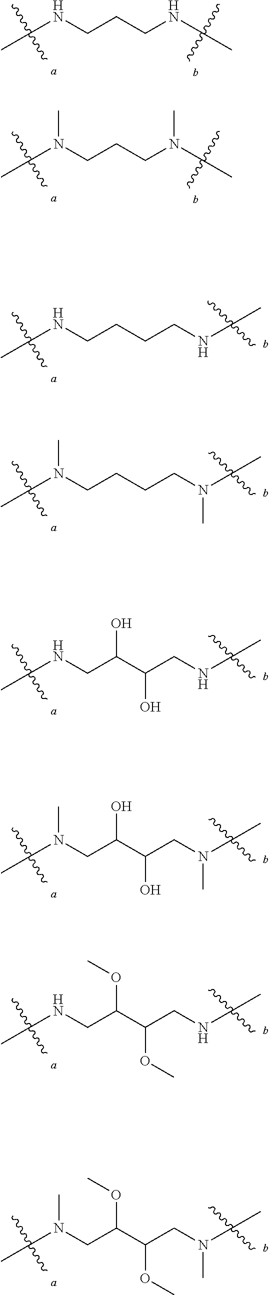
where the wavy line a represents a point of attachment to the rest of the constitutional repeating unit and the wavy lines b and, when present, c represent a point of attachment to the rest of the molecule.

9. The magnetic nanocomposite material according to claim 8, wherein each L is selected from the list of: 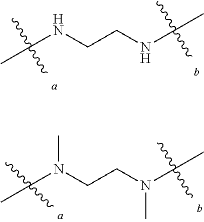
where the wavy line a represents a point of attachment to the rest of the constitutional repeating unit and the wavy line b represents a point of attachment to the rest of the molecule.

10. The magnetic nanocomposite material according to claim 1, wherein each final generation constitutional repeating unit comprising a plurality of end groups has the fragment formula 1a′ or 1b′: 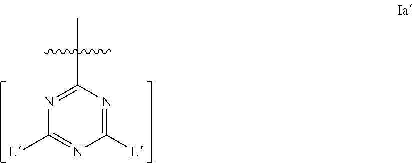
where:
the wavy line represents the point of attachment to the rest of the molecule;
each L′ independently represents an end group selected from NR^{1′}R^{2′} or SR^{3′};
each R^{1′} independently represents H or C₁ to C₆ alkyl, which C₁ to C₆ alkyl is unsubstituted;
each R^{2′} independently represents —(CHR^{4′})ₙNR^{5′}R^{6′};
each R^{3′} independently represents —(CHR^{4′})ₙSR^{7′};
each R^{5′} and R^{6′} independently represent H, C₁ to C₆ alkyl that is unsubstituted, —(CHR^{4′})ₙNR^{8′}R^{9′};
each n independently represents 2 to 6;
each R^{5′} and R^{9′} independently represent H, C₁ to C₆ alkyl, which C₁ to C₆ alkyl is unsubstituted, —(CHR^{4′})ₙNR¹⁰R^{11′};
each R^{10′} and R^{11′} independently represent H, C₁ to C₆ alkyl, which C₁ to C₆ alkyl is unsubstituted;
each R^{4′} represents H, OH or OR^{12′}; and
each OR^{12′} independently represents C₁ to C₃ alkyl, which C₁ to C₃ alkyl is unsubstituted; or 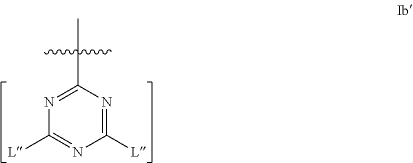
where:
the wavy line represents the point of attachment to the rest of the molecule;
each L″ independently represents an end group of formula 1c′: 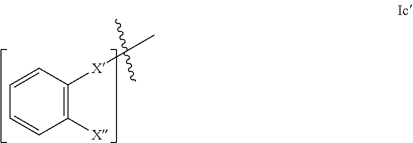
where:
the wavy line represents the point of attachment to the rest of the molecule;
each X′ independently represents S or NR^{13′};
each X″ independently represents SR¹⁴ or NR^{15′}R^{16′}; and
each R^{13′} to R^{16′} independently represents H or C₁ to C₃ alkyl, which C₁ to C₃ alkyl is unsubstituted.

11. The magnetic nanocomposite material according to claim 10, wherein each end group is selected from the list of: 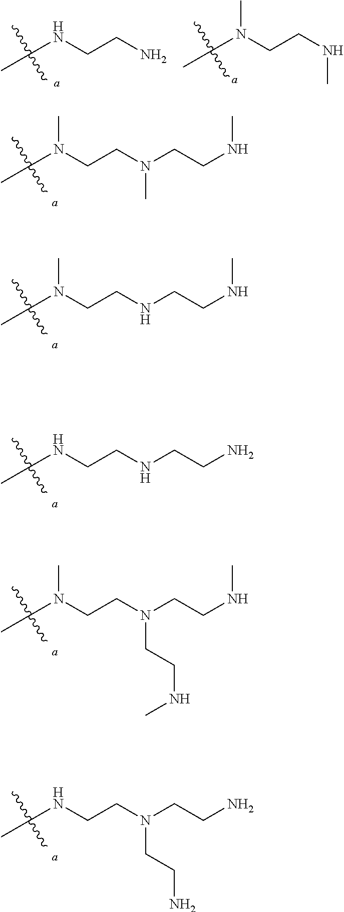 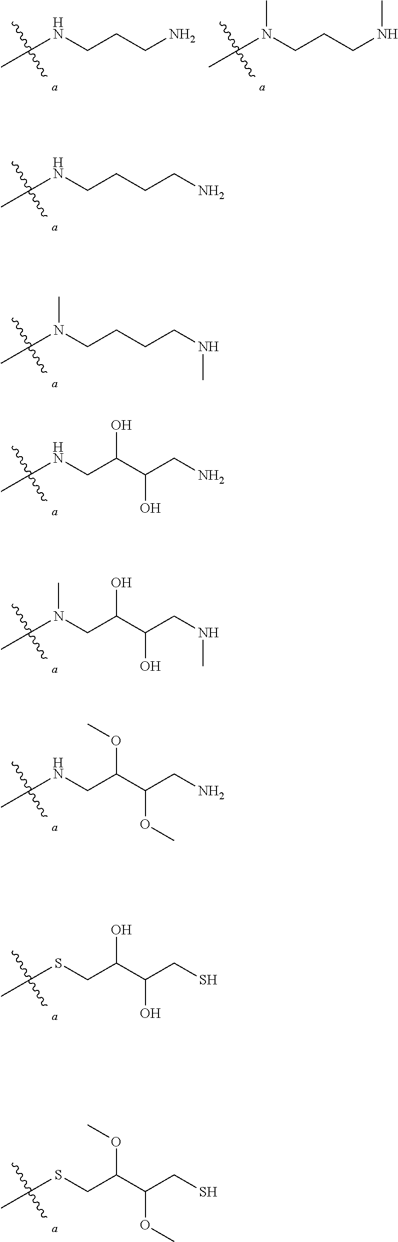 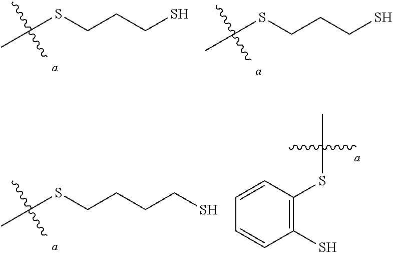 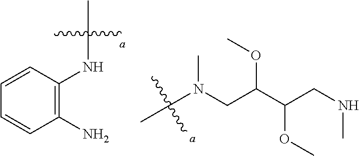 [SMILES: *Nc1ccccc1N ; *N(C)CC(OC)C(CNC)OC]
where the wavy line a represents a point of attachment to the rest of the final generation constitutional repeating unit.

12. The magnetic nanocomposite material according to claim 11, wherein each end group is selected from the list of: 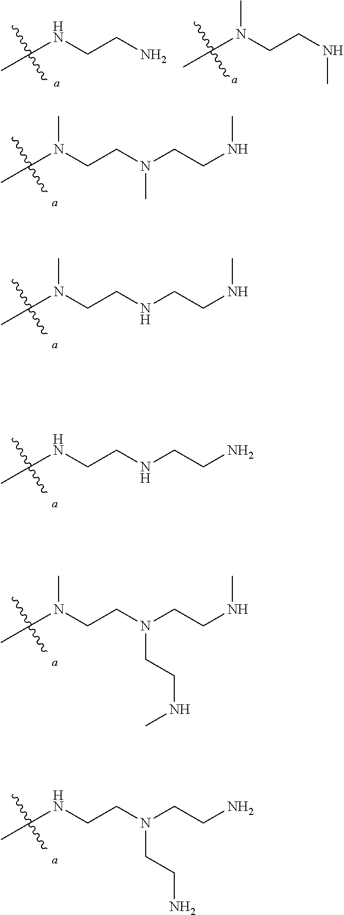 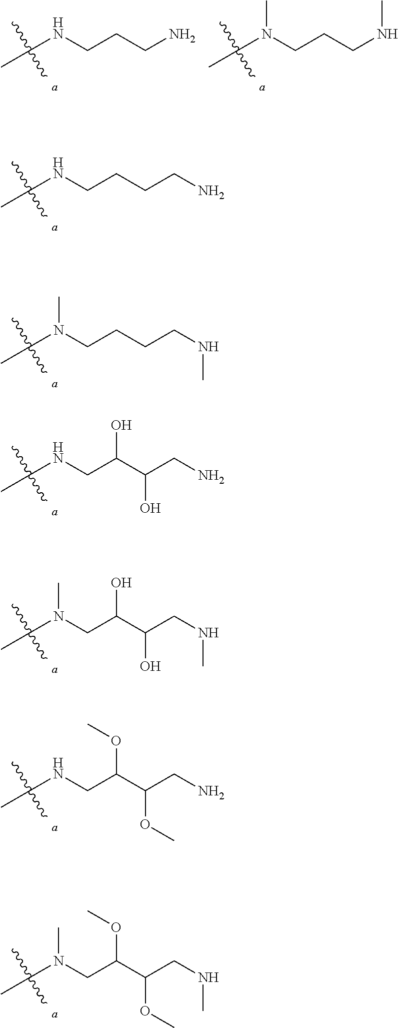
where the wavy line a represents a point of attachment to the rest of the final generation constitutional repeating unit.

13. The magnetic nanocomposite material according to claim 12 wherein each end group is selected from the list of: 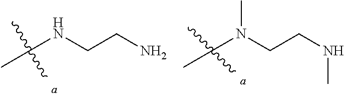
where the wavy line a represents a point of attachment to the rest of the constitutional repeating unit.

14. The magnetic nanocomposite material according to claim 1, wherein there are from 1 to m generations of non-final constitutional repeating units, where m is from 2 to 5.

15. (canceled)

16. The magnetic nanocomposite material according to claim 1, wherein the magnetic nanocomposite material has a diameter selected from one of the following ranges:
(ai) a diameter of from 5 to 100 nm; or
(aii) a diameter of from 200 to 500 nm.

17. A polymeric product comprising:
a polymeric matrix formed from at least one monomeric material having a vinyl group; and
a magnetic nanocomposite material according to claim 1.

18. The polymeric product according to claim 17, wherein the monomer in the polymeric product is selected from one or more of the group consisting of vinyl chloride, propylene, vinyl acetate, vinylidene chloride, styrene, acrylonitrile, tetrafluoroethylene, isoprene, butadiene, chloroprene, N-isopropylacrylamide, 2-hydroxyethyl methacrylate (HEMA), methyl methacrylate, ethylene glycol dimethacrylate, vinyl methacrylate, allyl methacrylate, 3-(acryloyloxy)-2-hydroxypropyl methacrylate, a dimethacrylate monomer, and triethylene glycol dimethacrylate.

19. The polymeric product according to claim 17, wherein the polymeric product has one or more of the following properties:
(bi) a tensile strength of from 1 to 20 MPa;
(bii) a Young's Modulus of from 10 to 300 MPa, such as from 15 to 20 MPa, such as 18 MPa; and
(biii) a toughness of from 0.10 to 0.50 MJ/m³.

20. A formulation comprising:
at least one monomeric material having a vinyl group; and
a magnetic nanocomposite material according to claim 1.

21. The formulation according to claim 20, wherein the monomer is selected from one or more of the group consisting of vinyl chloride, propylene, vinyl acetate, vinylidene chloride, styrene, acrylonitrile, tetrafluoroethylene, isoprene, butadiene, chloroprene, N-isopropylacrylamide, 2-hydroxyethyl methacrylate (HEMA), methyl methacrylate, ethylene glycol dimethacrylate, vinyl methacrylate, allyl methacrylate, 3-(acryloyloxy)-2-hydroxypropyl methacrylate, a dimethacrylate monomer, and triethylene glycol dimethacrylate.

22. A method of forming a polymeric material, the method comprising:
(ci) forming a mixture in a vessel comprising:
at least one monomeric material having a vinyl group
a magnetic nanocomposite material according to claim 1; and
a peroxide to form a mixture; and
(cii) allowing the mixture to form the polymeric material over a period of time.

23. (canceled)

24. (canceled)

25. (canceled)

26. (canceled)

27. (canceled)
